(19) United States
(12) Patent Application Publication
(10) Pub. No.: US 2025/0313414 A1
(43) Pub. Date: Oct. 9, 2025

(54) CONVEYOR BELT TRACKING APPARATUS AND SYSTEM

(71) Applicant: Flexible Steel Lacing Company, Downers Grove, IL (US)

(72) Inventor: Joannes Stefanus van't Schip, Ionia, MI (US)

(21) Appl. No.: 19/169,518

(22) Filed: Apr. 3, 2025

Related U.S. Application Data
(60) Provisional application No. 63/574,037, filed on Apr. 3, 2024.

(51) Int. Cl. B65G 39/16; B65G 43/00

(52) U.S. Cl. CPC B65G 39/16; B65G 43/00; B65G 2203/0283; B65G 2203/042

(57) ABSTRACT

A belt tracking apparatus for urging a mistracking conveyor belt towards a correct travel path is disclosed. The apparatus includes a rotatable pulley for engaging the conveyor belt and a support assembly configured to operatively mount the pulley in engagement with the conveyor belt. In some forms, the apparatus includes a sensor mounted for rotation with the pulley that is configured for detecting a position of a portion of the conveyor belt. The apparatus may include an actuator mounted in an internal space of the pulley. The actuator shifts an end portion of the pulley generally upstream or downstream relative to a belt travel direction of the conveyor belt for urging the conveyor belt back toward the correct travel path in response to the detected position of the belt portion indicating the conveyor belt is mistracking.

### CROSS-REFERENCE TO RELATED APPLICATION

This application claims the benefit of U.S. Provisional Application No. 63/574,037, entitled “Conveyor Belt Tracking Apparatus and System”, filed Apr. 3, 2024, which is hereby incorporated by reference in its entirety.

### FIELD OF THE INVENTION

The invention relates to tracking apparatuses and methods for tracking conveyor belts.

### BACKGROUND OF THE INVENTION

Rollers for conveyor belts are arranged so that the conveyor belt travels thereover in a downstream belt travel direction and path. However, conveyor belts can tend to meander or mistrack laterally toward one side or the other of the rollers due to reasons such as uneven loads carried by the belt. Mistracking can cause damage to the conveyor belt and conveyor structure, and in some cases can result in inaccurate positioning or spillage of material or products carried by the conveyor belt. In addition, the positioning of transported material might demand accurate belt tracking, especially if the transported material is being processed on the belt. Conveyor belt tracking devices have been developed that respond to belt mistracking to attempt to redirect the belt back to its correct travel path substantially centered on the conveyor rollers.

Belt tracking devices may be powered or unpowered. Some unpowered belt tracking devices are actuated by the conveyor belt to change their orientation, such as by means of friction, gravity or belt edge rollers. Powered belt tracking devices rely on one or more actuators to change their orientation, such as pneumatic or electric linear actuators. Powered belt trackers are typically used on conveyor belts that are more difficult to track. Such conveyor belts may be relatively short and/or relatively wide or may be subject to uneven or inconsistent loading, such as lateral side loads that result from loading or unloading material from a lateral side of the belt, instead of along the longitudinal belt travel direction of the belt. Further, for applications in which the position of the belt or products thereon require accurate positioning, powered belt trackers may be used.

Powered belt trackers typically rely on belt edge sensors positioned downstream of the belt tracker, such as contact or contactless sensors, to determine the position of the belt with respect to a known position, such as the belt tracker itself. Contact sensors directly contact the belt edge and may be pneumatic or electric. Contactless sensors are typically mounted downstream of the tracker near the belt edge but do not contact the belt itself, and instead sense the position of the edge of the belt. Such sensors include photocells, capacitive sensors, pneumatic sensors, and acoustic sensors. If the sensor senses a deviation from the desired position of the belt, it will cause the linear actuator to pivot the pulley into the correct position for making a correction.

There are some drawbacks associated with known powered belt trackers. For example, known powered belt trackers typically require numerous parts in addition to the tracking pulley itself, such as actuators, linear guides, sensors, pneumatic units, and controls. These additional parts need their own mounting features and brackets beyond those needed for the pulley so that these parts can be installed on or around the conveyor structure. Also, these additional parts need electrical and pneumatic lines to be installed in between them. All of this requires additional space and installation work for mounting these parts. In many cases it will be difficult to retrofit such powered belt trackers on existing conveyors.

Belt trackers with separate actuators, sensors and controls, including the electric and/or pneumatic lines between them, can become contaminated or fouled, such as by the material transported by the belt. If the belt edge sensors become sufficiently fouled, the belt tracker will lose the ability to operate properly. The various components can be difficult to keep clean, and therefore are not ideal for hygienic applications, such as food production. In addition, many powered belt trackers which include belt sensors positioned downstream of the pulley are not suitable for conveyor belts that are reversable, i.e., that can be run in opposite travel directions.

### SUMMARY

A belt tracking apparatus for urging a mistracking conveyor belt back towards a correct travel path is described herein. The apparatus and method both utilize upstream or downstream shifting of an end portion of a tracker pulley to direct or steer the belt back toward its correct travel path. The apparatus is preferably bi-directional for use with conveyor belts that may be run in opposite travel directions. In one form, the control electronics for sensing characteristics of the belt, such as the belt position, and for controlling the actuator are mounted to be integrated with the pulley, and the actuator is mounted to extend internally within an interior space of the pulley, resulting in a belt tracker that is more hygienic, that allows for simplified cleaning and maintenance, as well as simplified installation. In addition, because the belt position sensor is integrated with the pulley and the actuator is mounted internally to the pulley, these components are advantageously protected from the elements and from debris or other foreign material, offering improved reliability and performance. The arrangement of the belt position sensor and control electronics to be integrated with and mounted within the pulley also allows the belt tracker to more accurately detect and determine information regarding the position, movement, and tracking of the conveyor belt, as well as characteristics of the belt tracker itself and its installation.

### BRIEF DESCRIPTION OF THE DRAWINGS

FIG. 1 is a perspective view of a belt tracking apparatus in accordance with the present invention showing a motion converter at a shiftable end portion of the belt tracking apparatus.

FIG. 2 is a perspective view of the belt tracking apparatus of FIG. 1 showing a pivot support assembly at an opposite end portion of the belt tracking apparatus about which the pulley of the belt tracking apparatus is pivotable.

FIG. 3 is a plan view of the belt tracking apparatus of FIG. 1 showing a neutral position of the pulley extending laterally orthogonal to the belt travel direction. An outer pulley lagging is removed from an outer surface of the pulley to show a belt position sensor assembly on the outer surface of the pulley tubular body at the shiftable end portion of the pulley.

FIG. 4A is a perspective view of the belt tracking apparatus of FIG. 1 showing the pulley lagging and one half of the pulley removed so that internal components of the belt tracker are visible including an actuator assembly including a transmission, a rotatable support shaft connected to the transmission, control electronics and roller bearing assemblies for rotatably supporting the pulley.

FIG. 4B is an exploded perspective view of the pivot support assembly of the belt tracking apparatus of FIG. 1.

FIG. 5A is a perspective cross-sectional view of the belt tracking apparatus of FIG. 1 through a vertical plane defined by the pulley longitudinal axis L and pivot axis P showing the support assembly and other internal components of the belt tracker within the pulley.

FIG. 5B is a cross-sectional view of the pivot end portion of the belt tracking apparatus of FIG. 1 showing the stationary support shaft pivotally received in the pivot support member.

FIG. 5C is a cross-sectional view of a central portion of the belt tracking apparatus of FIG. 11 showing the actuator assembly connected to interior ends of the rotatable support shaft and the stationary support shaft.

FIG. 6A is a perspective view of the shiftable end portion of the belt tracking apparatus of FIG. 1 with the pulley removed to show the rotatable and partially rotatable portions of the control electronics and the motion converter for converting rotatable motion of the rotatable support shaft into a generally upstream and downstream movement of the shiftable end portion of the apparatus.

FIG. 6B is an exploded perspective view of the shiftable end portion of the belt tracking apparatus of FIG. 1 with the pulley and motion converter removed to show the rotatable support shaft, the fully rotatable and partially rotatable portions of the control electronics, an end plate assembly, and the belt position sensor assembly.

FIG. 7A-7C are plan views of the belt position sensor assembly, the fully rotatable portion of one control electronics PCB and a partially rotatable portion of another control electronics PCB, respectively.

FIG. 7D is an exploded perspective view of the belt position sensor assembly of FIG. 7A showing a plurality of layers of a PCB body of the sensor assembly.

FIG. 8 is a block diagram of a control system of the belt tracking assembly of FIG. 1.

FIG. 9 is a perspective view of the motion converter of the belt tracking apparatus of FIG. 1 in an unshifted or neutral position.

FIG. 10 is a side view of the motion converter of FIG. 9 in a first shifted orientation corresponding with an aft or upstream shifting of the shiftable end portion of the belt tracking apparatus relative to the belt travel direction shown in FIG. 3.

FIG. 11 is a side view of the motion converter of FIG. 9 in a second shifted orientation corresponding with a fore or downstream shifting of the shiftable end portion of the belt tracking apparatus relative to the belt travel direction shown in FIG. 3.

FIG. 12 is an exploded perspective view of the motion converter of the belt tracking apparatus of FIG. 1.

FIG. 13 is a partially exploded perspective view of an alternative motion converter for converting rotational motion of an internal actuator to upstream and downstream shifting of a shiftable end portion of a belt tracking apparatus.

FIG. 14 is a plan view of an alternative embodiment of the belt tracking apparatus showing a shiftable end portion of the apparatus shifted in a downstream direction relative to the belt travel direction such that the pulley extends transversely and laterally non-orthogonally or obliquely to the belt travel direction for directing the belt away from the shiftable end.

FIG. 15 is a plan view of the belt tracking apparatus of FIG. 14 showing a shiftable end portion of the apparatus shifted in an upstream direction relative to the belt travel direction such that pulley extends transversely and laterally non-orthogonally or obliquely to the belt travel direction for redirecting the mistracking belt toward the shiftable end.

FIG. 16 is a side view of a schematic representation of a conveyor belt system illustrating one possible mounting location of the belt tracking apparatus of FIG. 1 along a return run of the conveyor belt adjacent to a return pulley.

FIG. 17 is a side view of a schematic representation of the return pulley of the conveyor belt system of FIG. 16 including the adjacent belt tracking apparatus showing an installation orientation of the belt tracking apparatus and a belt wrap in contact with the pulley of the belt tracking apparatus.

FIG. 18 is a graphical representation of the signals output from the belt position sensor with an upper row of pulses representing the position of the belt relative to the belt position sensor as the sensor rotates with the pulley.

FIG. 19 is a perspective view of alternative belt tracking apparatus in accordance with the present invention showing a motion converter in the form of a lever at a shiftable end portion of the belt tracking apparatus.

FIG. 20 is a perspective view of the belt tracking apparatus of FIG. 19 with the lagging removed to show the sensor assembly at the pivot end portion of the belt tracking apparatus and also showing a support assembly in the form of a leaf spring support assembly at the end portion about which the pulley of the belt tracking apparatus is pivotable.

FIG. 21 is a perspective view of the belt tracking apparatus of FIG. 19 showing the pulley removed so that internal components of the belt tracker are visible including an actuator assembly having a transmission, a rotatable support shaft connected to the transmission and roller bearing assemblies for rotatably supporting the pulley.

FIG. 22 is a perspective cross-sectional view of the belt tracking apparatus of FIG. 19 through a vertical plane showing the support assembly, actuator assembly and other internal components of the belt tracker within the pulley.

FIG. 23 is a perspective view of an actuator, a stationary support shaft, a position sensor, an end cap assembly configured for mounting a rotatable portion of one control electronics PCB, and a leaf spring support assembly of the belt tracking apparatus of FIG. 19, wherein the position sensor includes a magnetic field interface integrated circuit PCB and a target member that shifts along with the transmission housing through a predetermined range of rotational displacement.

FIG. 24 is a schematic side view of a shiftable end portion of the belt tracking apparatus including the lever illustrating the arcuate travel path of the shiftable end portion including fore and aft and vertical components thereof when shifted in the generally upstream and downstream directions relative to the belt travel direction.

FIG. 25 is an exploded perspective view of an alternative belt position sensor assembly showing a plurality of layers of a PCB body of the sensor assembly including an electrically conductive border extending about the capacitive sensor electrodes for providing static charge protection.

FIG. 26 is a plan view of the belt position sensor assembly of FIG. 25.

### DETAILED DESCRIPTION

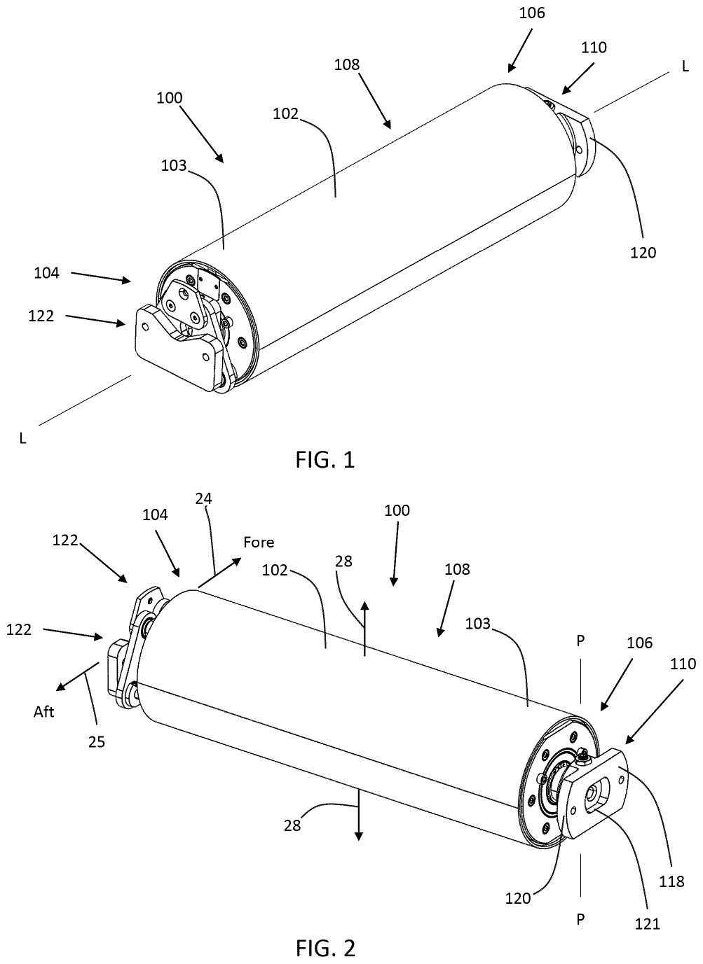

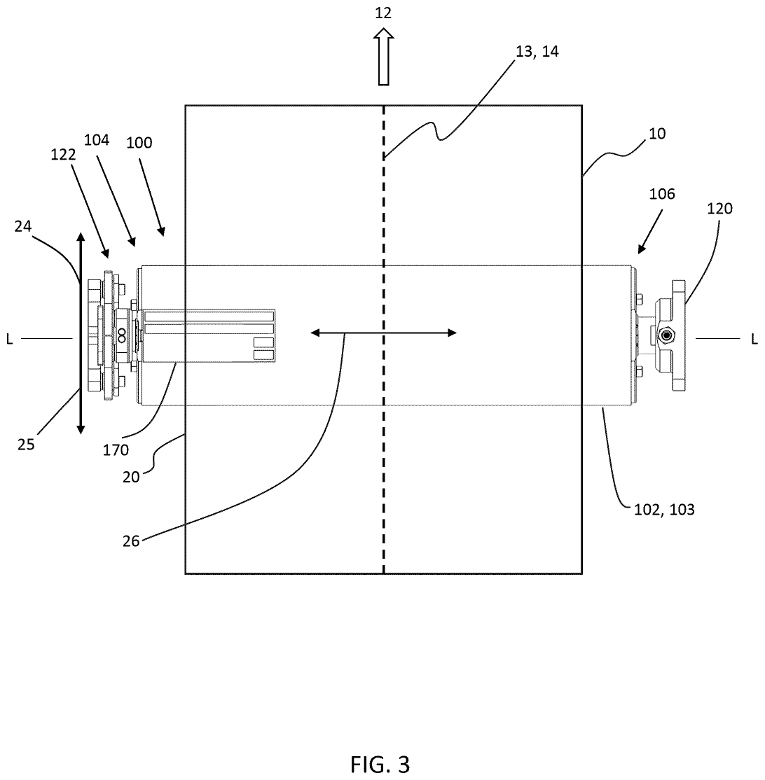

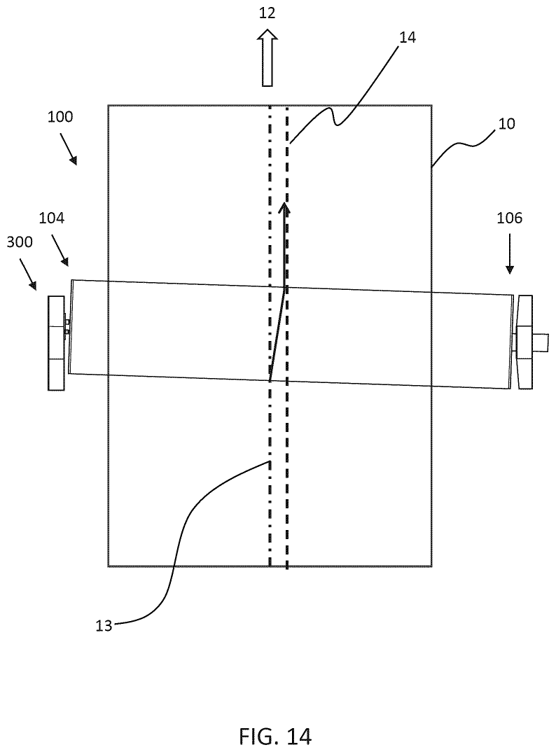

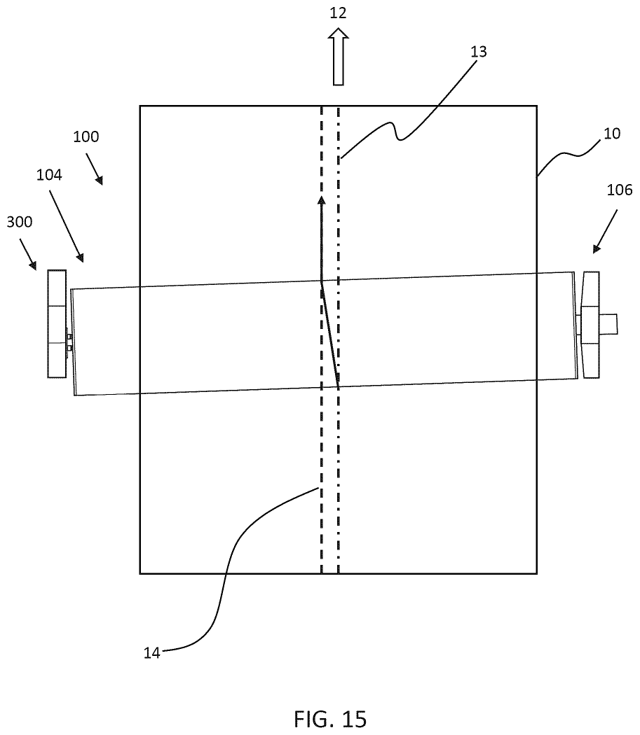

As illustrated in FIGS. 1-18, a conveyor belt tracking apparatus 100 is disclosed that is adapted to be used with an endless conveyor belt system 30 positioned in contact with a conveyor belt 10 thereof to track the belt 10 along a generally longitudinal belt travel path or direction 12, the center line 14 of the correct belt travel path 12 being indicated in FIG. 3. Accordingly, the belt tracking apparatus 100 is configured to correct lateral misalignment of a center line 13 of the belt 10 relative to the correct belt travel path center line 14. The belt tracking apparatus 100 includes a rotatable pulley 102 having opposite end portions including a shiftable end portion 104 that is configured to be shifted generally upstream and downstream or forwardly and rearwardly in the fore and aft directions 24, 25 relative to a belt travel direction 12 as shown in FIGS. 14 and 15, and a pivot end portion 106 that is located adjacent to a pivot support member 120 about which the pivot end portion 106 pivots. As used herein, the terms “laterally outer”, “laterally outward” and “outer” generally refer to components or portions that face away from a geometric center of the pulley 102 (located at the intersection of center lines 13 and 14 and lateral direction 26 shown in FIG. 3) or are located relatively further away from the geometric center toward one end of the pulley 102 or the other in either lateral direction 26. The terms “laterally inner”, “laterally inward” and “inner” generally refer to components or portions that face toward the geometric center of the pulley 102 or are located relatively closer to the geometric center from one end of the pulley 102 or the other in the lateral direction 26.

As shown in FIGS. 1-5C, the belt tracking apparatus 100 has a pulley assembly 108, including the pulley 102 having a body 102A and optionally pulley lagging 103 thereon, being mounted for rotation about the pulley longitudinal axis L to a support assembly 110. The pulley body 102A is tubular having a generally annular or cylindrical configuration and may include pulley lagging 103 attached to a belt facing surface 105 of the pulley body 102A for engaging with a surface of the conveyor belt 10. The pulley body 102A may be made of an insulative and radiotransparent material, such as fiberglass, to allow for proper operation of belt position sensor assembly 170 attached to pulley body 102A to be integrated therewith and to allow wireless communication to and from control circuitry 202 within the pulley, as will be described further hereinafter.

The lagging 103 may be of a rubber or polymeric material such as urethane so that sufficient friction with the belt 10 is present to enable steering of the belt by the pulley 102. The lagging 103 also physically protects the belt position sensor assembly 170 when mounted to the belt facing surface 105 of the pulley body 102A so that the belt sensor assembly 170 is integrated in or with the annular wall or wall assembly 102B of the pulley 102. In addition, the lagging material may include an additive or additional components to increase the electrical conductivity of the lagging 103 so that any static charge generated on the pulley 102 can be dissipated or directed away from the pulley assembly 108 including its control circuitry 202. In addition, the pulley body 102A and/or lagging 103 thereon can include a conductor operably connected to a part of the conveyor system frame structure to provide a conductive path to ground to dissipate any static charge to protect the belt position sensor assembly 170 and control circuitry 202. For example, a self-adhesive metallic tape can be applied to the belt facing surface 105 of the pulley body 102A adjacent to belt position sensor assembly 170 and extending to either end 104, 106 of the pulley 102 and in contact with end plates 175A, 175B of the support assembly 110 that are mounted in opposite end openings 107A, 107B of the pulley body 102A.

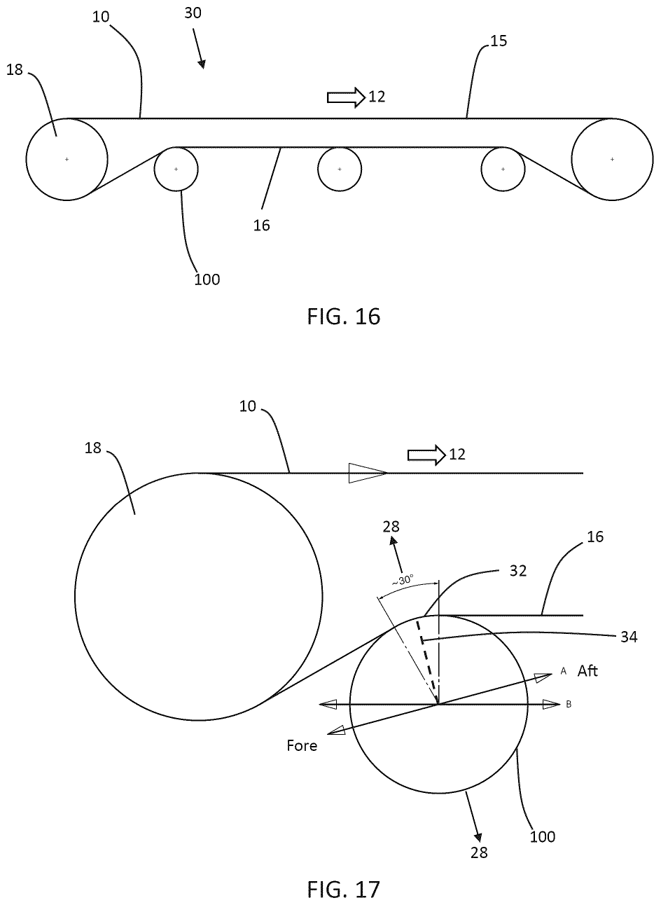

The support assembly 110 of the pulley assembly 108 is configured to operatively mount the pulley 102 to a conveyor system frame structure with the pulley 102 extending transversely with respect to a belt travel direction 12 of the conveyor belt 10 in contact with a return run 16 of the conveyor belt 10, such as adjacent to a return roller 18 shown in FIGS. 16 and 17. In this regard, the pulley 102 generally extends in the lateral or transverse direction 26 across the conveyor belt 10. The support assembly 110 is further configured to allow the pulley 102 to be shifted relative to the conveyor belt 10 when the conveyor belt 10 is mistracking, from the neutral position with the longitudinal rotary axis L of the pulley 102 extending in the lateral direction 26 perpendicular to the belt travel direction 12 when the belt 10 is traveling on the correct travel path shown in FIG. 3, to an oblique, non-perpendicular orientation of the longitudinal axis L of the pulley relative to the belt travel direction 12 so that the shiftable end portion 104 of the pulley 102 is further downstream (FIG. 14) or upstream (FIG. 15) than opposite pivot end portion 106 thereof for directing the belt 10 back toward the correct travel path.

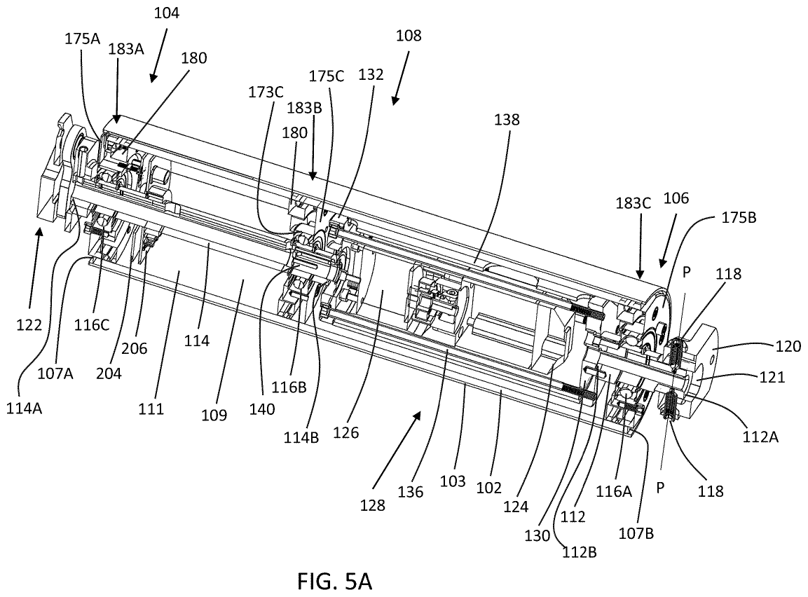

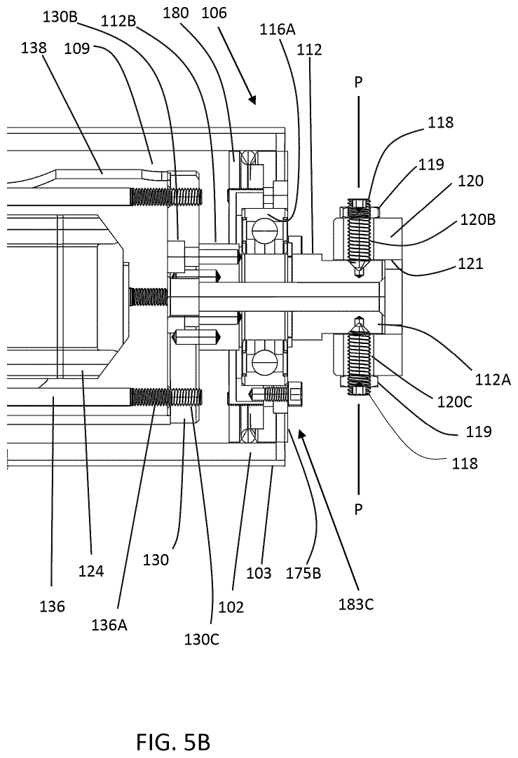

As best shown in FIG. 5A, the support assembly 110 includes a support shaft 112 that is referred to as stationary in that it is non-rotatable about its longitudinal axis. The stationary support shaft 112 extends generally along the lateral direction 26 from the pivot end portion 106 of the pulley assembly 108. The support assembly 110 also includes a rotatable support shaft 114 that extends generally along the lateral direction 26 from the opposite shiftable end portion 104 of the pulley assembly 108. Together, the shafts 112, 114 support the pulley 102 for rotation thereabout via roller bearing assemblies 116A-C mounted on the support shafts 112, 114 relative to a stationary conveyor system support frame or other external support structure (not shown).

In particular, one roller bearing assembly 116A is mounted on the stationary support shaft 112 to extend therearound at pivot end portion 106 of the pulley 102 between the opposite ends 112A and 112B of the shaft 112. Roller bearing assemblies 116B and 116C are also mounted about the rotatable support shaft 114 to extend therearound adjacent either end 114A and 114B thereof. The outer roller bearing assemblies 116A and 116C are part of end cap assemblies 183A, 183C each positioned in the interior end openings 107A, 107B of the pulley body 102A so as to be rotatable with the pulley body 102A and which are described in further detail below. Intermediate bearing assembly 116B is part of a similarly configured intermediate rotatable support assembly 183B.

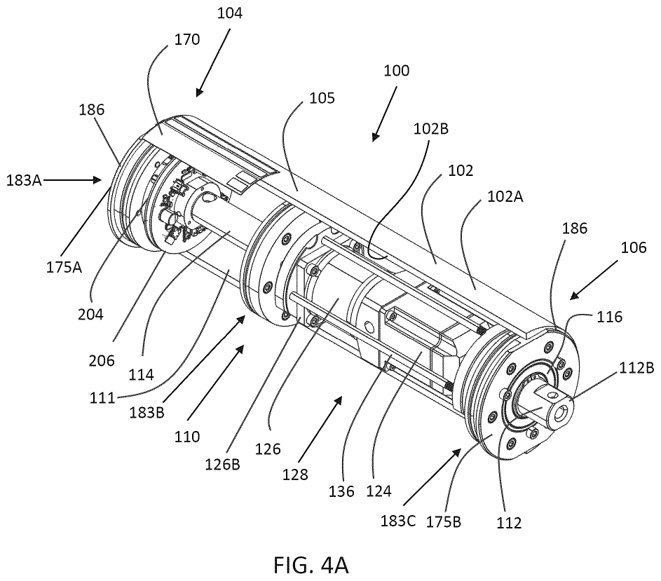

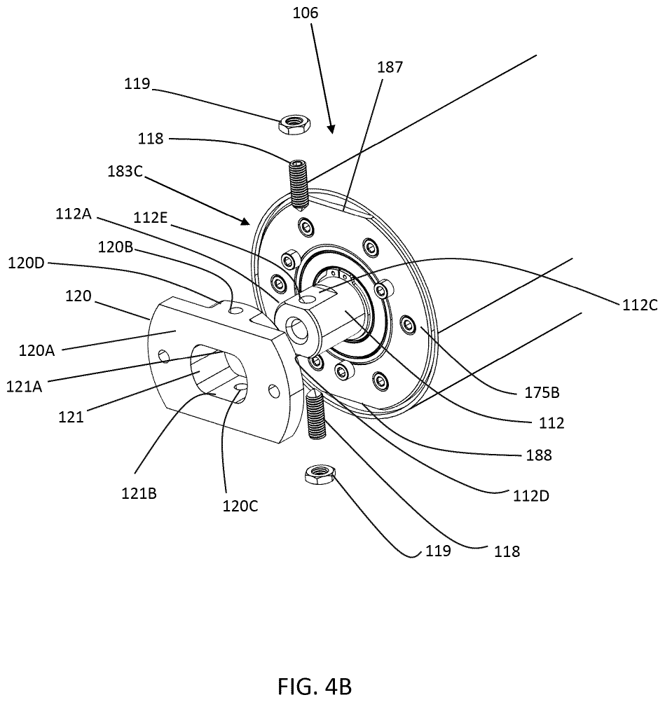

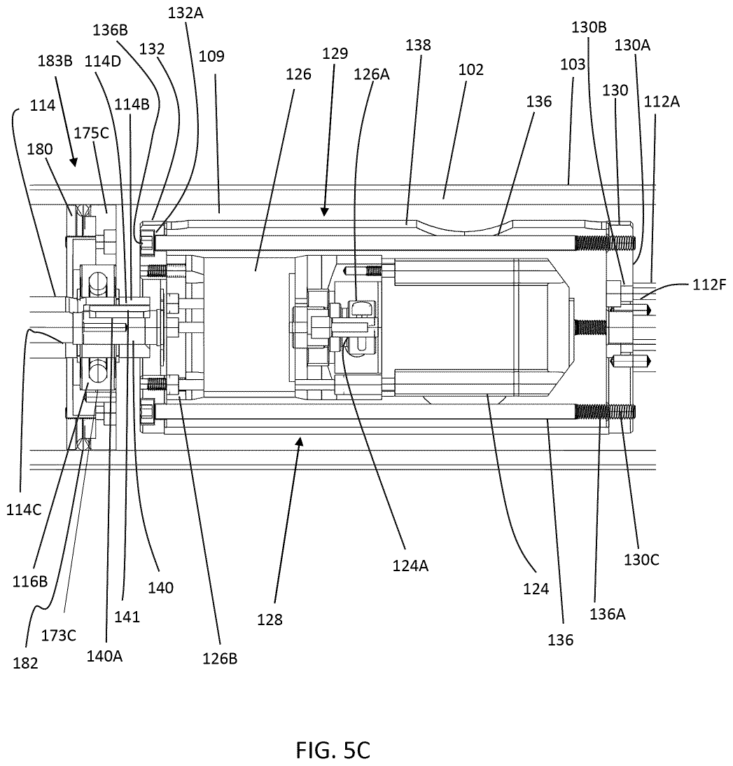

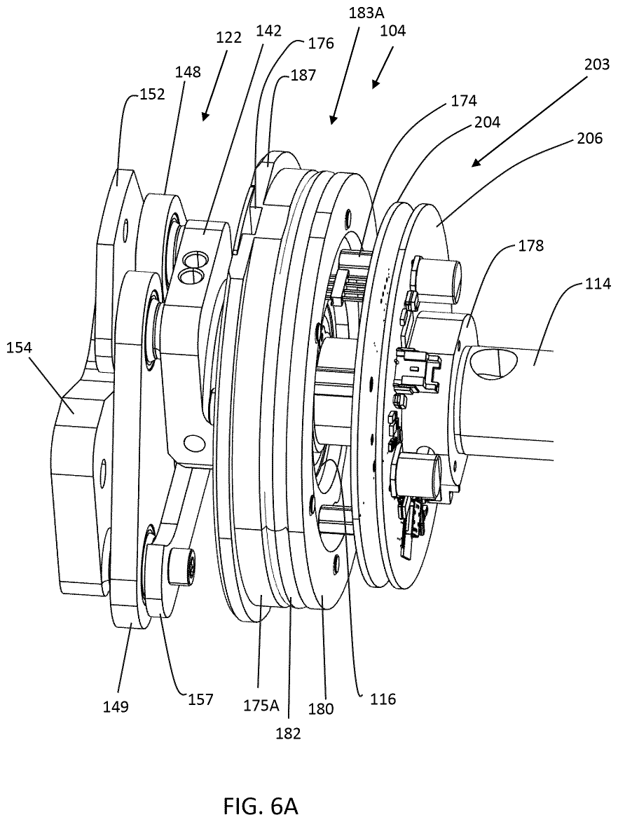

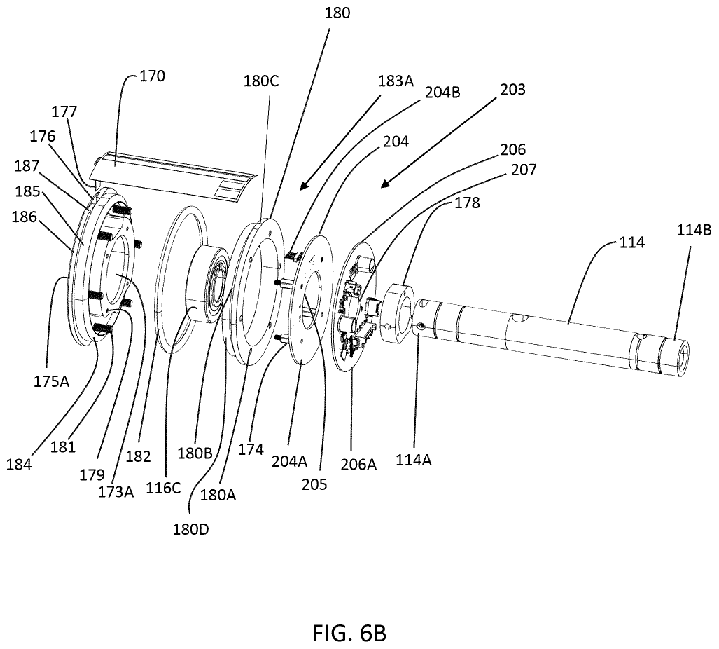

End cap assemblies 183A and 183C each include an end plate 175A, 175B, a roller bearing assembly 116A, 116C, an O-ring 182, and an annular compression member 180. The end cap assemblies 183A, 183C are operable to allow the pulley 102 to rotate about the rotatable support shaft 114 and stationary support shaft 112, as well as cover and seal interior end openings 107A, 107B of the pulley body 102A so as to inhibit the entry of foreign materials, such as liquid, dust or debris into pulley internal space 109, and protect the internal components inside of the pulley assembly 108. End cap assembly 183A will now be described for reference, which description similarly applies to end cap assembly 183C and intermediate support assembly 183B. As shown in FIGS. 6A and 6B, an outer race of the outer roller bearing assembly 116C is mounted with a friction fit within annular opening 173A of the end plate 175A. Annular compression member 180 includes a larger diameter flange portion 180C which extends radially from a laterally outwardly extending sleeve portion 180D having a relatively smaller diameter. The annular compression member 180 is fixed via the flange portion 180C to an inner facing side of the end plate 175A via a plurality of threaded screws 181 that are received in corresponding threaded openings 180A disposed about the body of the flange portion 180C. The sleeve portion 180D of annular compression member 180 is received in a corresponding laterally inwardly extending sleeve portion 185 of end plate 175A, which has a slightly larger inner diameter relative to the outer diameter of the sleeve portion 180D. A lip portion 186 extends radially outwardly from a laterally outer end of sleeve portion 185 and extends substantially entirely around a perimeter of end plate 175A, except for at flattened top and bottom portions 187, 188 thereof, which are shown in FIG. 4B with respect to end plate 175B. The lip portion 186 abuts the end of the pulley body 102A, as shown in FIG. 4A with respect to end plate 175B. As shown in FIGS. 5A, 6A and 6B, An O-ring 182 of an elastomeric material extends around the perimeter of the end cap assembly 183A and resiliently engages with the interior surface 111 of the pulley body 102A to fix the end cap assembly 183A to the pulley body 102A and to form a seal therebetween. The O-ring 182 is compressed between corresponding annular surfaces 184 and 180B of the end plate 175A and of the annular compression member 180, respectively. As shown in FIG. 5C, intermediate rotatable support assembly 183B is similarly configured to end cap assemblies 183A and 183C and is formed by intermediate bearing assembly 116B, annular compression member 180, intermediate plate member 175C, and O-ring 182.

As shown in FIGS. 4A-5B, stationary support shaft 112 has one end 112B disposed in internal space 109 of the pulley annular or cylindrical body 102A and is connected at its other externally protruding end 112A to a pivot support member 120 via a pair of aligned fasteners such as pins or set screws 118 and corresponding nuts 119 that allow the stationary support shaft 112 to pivot about a generally vertical pivot axis P that extends orthogonally to the pulley longitudinal axis L and is aligned with the longitudinal axes of the set screws 118. The pivot support member 120 includes a central through opening 121 that extends sufficiently in the lateral direction 26 and is elongated in the fore and aft directions 24, 25 for receiving the laterally outer end 112A of the stationary support shaft 112 so that the stationary support shaft 112 has clearance to pivot therein about pivot axis P. The set screws 118 are received in corresponding vertically aligned and threaded vertically extending through openings 120B, 120C formed in upper and lower portions of a generally cylindrical collar portion 120D of pivot support member 120 that extends laterally inwardly from flanged body 120A and extend about the central opening 121 for receiving shaft end 112A therein. The stationary support shaft 112 includes vertically upper and lower flat surfaces 112C, 112D in which tapered recesses 112E are formed for receiving the conical tips of the set screws 118 therein. The tapered recesses 112E form a sliding interface with the conical tips of the set screws 118 such that the stationary support shaft 112 is allowed to pivot about the pivot axis P. The central opening 121 of pivot support member 120 includes corresponding upper and lower flat surfaces 121A, 12B that allow the support shaft 112 to pivot therein and also restrict rotational movement of the stationary support shaft 112 about its longitudinal axis. The pivot support member 120 has a flanged body 120A extending in the fore and aft directions 24, 25 from the generally cylindrical collar portion 120D with through openings for receiving fasteners to fix the pivot support member 120 to conveyor support frame structure.

As shown in FIGS. 4A and 5A-5C, the belt tracking apparatus 100 includes an internal actuator 124 mounted to extend in the internal space 109 of the pulley body 102A for shifting the position of shiftable end portion 104 of the pulley 102 with respect to the conveyor belt 10 in generally in the fore and aft directions 24, 25, i.e. a generally upstream and downstream direction relative to the belt travel direction 12. In one form, the actuator 124 is an electric motor, such as a DC stepper motor. The electric motor 124 is mounted at the pivot end portion 106 to extend in the pulley body 102A and is oriented such that its drive shaft 124A is aligned with the longitudinal axis L of the pulley 102 and extends towards the shiftable end portion 104 of the pulley 102. The drive shaft 124A of the motor 124 is fixedly received in an input shaft 126A of a transmission 126. The transmission 126 may take any variety of known forms and the internal components thereof are not shown for purposes of clarity. In one form, the transmission 126 is a planetary gearbox transmission 126 that is operable to increase the torque output by the motor 124 and reduce the speed of the motor's output, such as by a ratio of 50:1, although other gear ratios are contemplated. The output shaft 140 of the transmission 126 is received in a bore 114C of rotatable support shaft 114 at end 114B thereof and fixed against rotation relative to the rotatable support shaft 114 for rotating the rotatable support shaft 114 in either rotary direction about its longitudinal axis.

In other embodiments, the actuator 124 may be positioned externally to the pulley assembly 108. In this form, the actuator 124 may be an electric motor and transmission mounted adjacent to the pivot end portion 106 and connected to a rotatable support shaft that extends laterally through the entire pulley 102 and drives a motion converter 122 adjacent to the shiftable end portion 104 of the pulley 102. Alternatively, a pneumatic or electric linear actuator could be mounted externally to the pulley assembly 108 adjacent the shiftable end portion 104 for shifting the shiftable end portion of the pulley 102 upstream or downstream in the fore and aft directions 24, 25 with respect to the conveyor belt 10 about the pivot end portion 106.

The electric motor 124 and transmission 126 form part of an actuator assembly 128 that interconnects an internal end 112B of the stationary support shaft 112 to an internal input end 114B of the rotatable support shaft 114 within the internal space 109 of the annular or cylindrical body 102A of the pulley 102. The actuator assembly 128, together with the support shafts 112, 114, pivot support member 120 and motion converter 122 support the pulley 102 and form part of the support assembly 110.

As shown in FIG. 5A-5C, the actuator assembly 128 has a housing 129 that includes opposing circular end plates 130, 132 which are connected via four elongate support rods or bolts 136 that extend therebetween. A cylindrical support tube 138 of the housing 129 extends about the elongate support rods 136 and is held in place via compression between the opposing circular end plates 130, 132 for increasing the rigidity of the housing 129 of the actuator assembly 128.

The internal end 112B of the stationary support shaft 112 is fixed to end plate 130 at a laterally outer-facing surface 130A thereof via fasteners that extend through counterbored through holes 130B in circular end plate 130 and are received in corresponding longitudinally extending blind holes 112F in the end 112A of stationary support shaft 112. Threaded ends 136A of the elongate support rods 136 are received in corresponding threaded apertures 130C spaced about the periphery of the end plate 130. Bolt head ends 136B of the elongate support rods 136 are received in corresponding counterbored through openings 132A formed in the opposite end plate 132.

The output end of transmission 126 housing includes a mounting plate or flange 126B that is fixed to pivot-facing inner side of the end plate 132 via a plurality of fasteners such that the transmission 126 and motor 124 connected thereto are supported in a cantilevered manner from the end plate 132. The output shaft 140 of the transmission 126 extends in clearance through a central aperture in the end plate 132 and is fixedly received in the bore 114C of the interior end 114B of the rotatable support shaft 114. As shown in FIG. 5C, output shaft 140 and the interior surface of the bore 114C include corresponding grooves or keyways 140A, 114D for receiving a mating key 141 therein to provide a spline connection therebetween for rotatably fixing the output shaft 140 to the rotatable support shaft 114. In this manner, the actuator assembly 128 extends between and interconnects the interior ends 114B,112A of the shafts 114, 112 to provide a load path between the shafts 114, 112 for supporting the pulley assembly 108 for rotation thereabout.

The rotatable support shaft 114 extends from in the pulley internal space 109 laterally outwardly beyond from the shiftable end portion 104 of the pulley 102 for supporting the shiftable end portion 104 relative to the conveyor system support frame. The rotatable support shaft member 114 is rotatable by the actuator 124 in a limited manner, such as 30 degrees in either rotary direction about its longitudinal axis, which is aligned with pulley longitudinal axis L. Other ranges of motion are possible, such as up to 180 degrees in either rotary direction, depending on the amount of rotation needed to move the shiftable end portion 104 generally upstream or downstream. The rotatable support shaft 114 is connected to the conveyor system support frame via a shiftable connection, such as a motion converter 122 adjacent the shiftable end portion 104 to allow shifting of the pulley 102 generally in the fore and aft directions 24, 25 (i.e. generally upstream and downstream relative to belt travel direction 12) about the pivot axis P of the pivot support member 120. More particularly, because the pulley 102 pivots on an arcuate path for shifting in the fore and aft directions 24, 25, this upstream and downstream movement of the shiftable end portion 104 of the pulley 102 is a compound movement that also includes a lateral component of movement in the lateral direction 26. However, in other forms, the pulley assembly 108 may be supported by different forms of shiftable and/or pivot connections at either end portion 104, 106 thereof such that the shiftable end portion 104 may be configured to move in a path that is linear or a path that has linear and arcuate segments.

The motion converter 122 is part of the belt tracker support assembly 110 and supports the shiftable end portion 104 of the pulley assembly 108 via mounting to conveyor system support structure. In one form shown in FIGS. 1-3, 5A, 6A, and 9-12, the motion converter 122 is a pivotal linkage mechanism that is configured to convert rotation of the rotatable support shaft 114 to a generally upstream or downstream movement of the shiftable end portion 104 of the pulley 102.

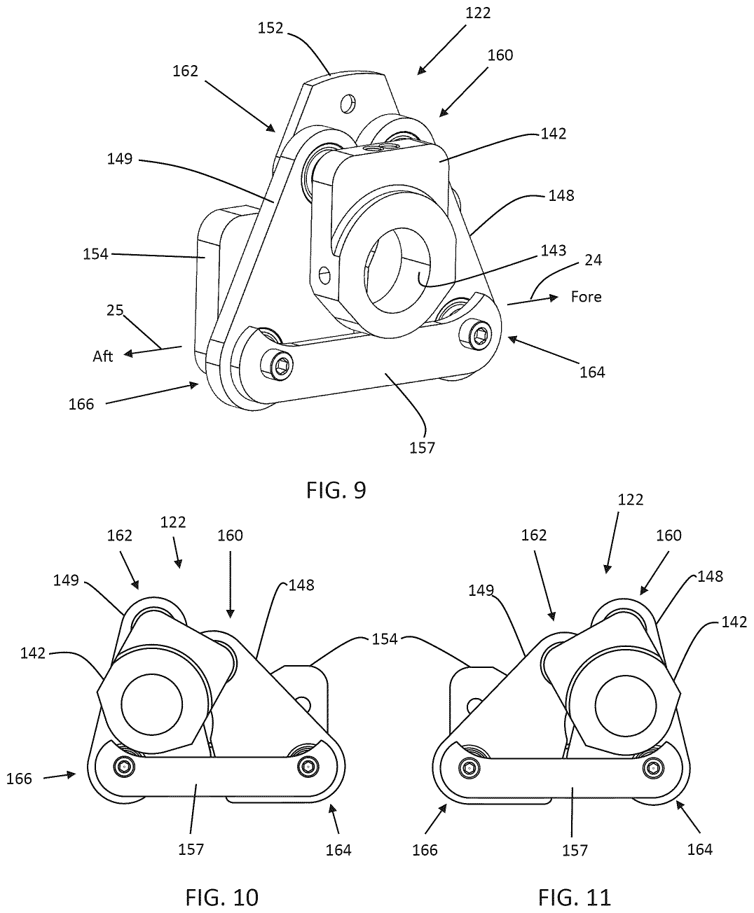

Now, referring to FIGS. 9-12, the motion converter 122 includes forward and rearward upper shiftable pivots 160, 162 and forward and rearward lower fixed pivots 164, 166, about which the forward and rearward upper shiftable pivots 160, 162 are pivotable, respectively so that the shiftable pivots 160, 162 can move forwardly and rearwardly in the fore and aft directions 24, 25 as they pivot about the forward and rearward lower fixed pivots 164, 166. The motion converter 122 includes a rotatable or pivotal input member 142 which includes a through opening 143 sized for receiving a laterally outer end portion 114A of the rotatable support shaft 114. The rotatable support shaft 114 is fixed against rotation within the opening 143 with appropriate fasteners, such as set screws, such that rotation of the rotatable support shaft 114 causes a corresponding rotation of the rotatable input member 142.

The forward and rearward shiftable pivots 160, 162 are formed in part by a pair of spaced-apart upper cylindrical bosses 144 that extend from a laterally outer side of the rotatable input member 142 above the opening 143 and upon which a pair of bearings 145A, 145B are mounted. The bearings 145A-D may be radial spherical plain bearings, which allow for rotational movement of the rotatable input member 142 and rotatable support shaft 114 about the longitudinal axis L, as well as rotational movement of the rotatable support shaft 114 and rotatable input member 142 in either direction about pivot axis P within a limited range of rotary motion so that the shiftable end portion 104 can be shifted. Accordingly, the spherical plain bearings 145A-D allow for movement of the rotatable support shaft 114 both in the fore and aft directions 24, 25 as well as in the lateral direction 26. Depending on the length of the pulley 102, the range of motion of the shiftable end portion 104 varies. In one form, the shiftable end portion 104 is configured to be rotated approximately 1 inch in either direction about pivot axis P and the length of the pulley 102 between the opposite ends thereof is approximately 16 inches.

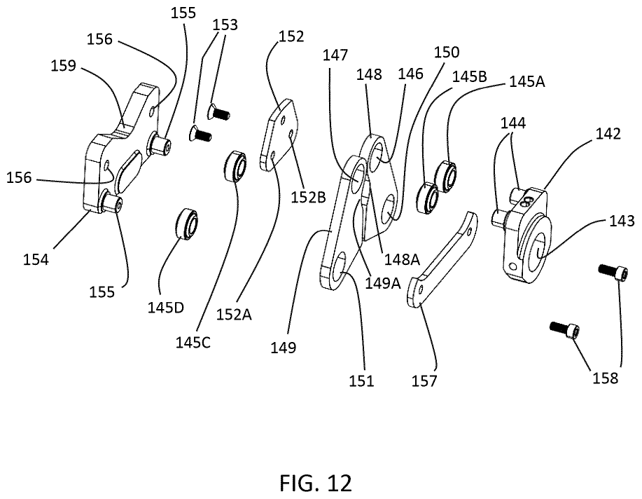

The forward bearing 145A is received in a corresponding upper through opening 146 of a forward link 148 and rearward bearing 145B is received in an upper through opening 147 of a similarly-shaped rearward link 149, as can be seen best in FIGS. 9 and 12. The upper through openings 146, 147 have arcuate or spherical surfaces to match the arcuate or spherical outer races of the bearings 145A, 145B. The forward and rearward links 148, 149 are each generally triangular shaped plate-like link members that include recessed arcuate facing edge portions 148A, 149A that provide clearance for one of the upper portions of the forward and rearward links 148, 149 to be pivoted toward the other about the lower fixed pivots 164, 166, as best seen in FIGS. 10 and 11.

Referring to FIGS. 9 and 12, an upper end plate 152 is mounted against laterally outer facing surfaces of the forward and rearward links 148, 149 via fasteners 153 that extend through lower apertures 152A, 152B in the upper end plate 152 and are received in threaded bores of the upper bosses 144 of rotatable input member 142. The forward link 148 and the rearward link 149 each include lower through openings 150 and 151, respectively, that each receive a bearing 145C, 145D of the forward and rearward fixed pivots 164, 166 therein, which may also be radial spherical plain bearings to allow both rotational movement of the forward link 148 and rearward link 149 about axes of lower cylindrical bosses 155 as well as limited rotation of the forward and rearward links 148, 149 about pivot axis P caused by the pivoting movement of the rotatable support shaft 114 about the pivot axis P.

Stationary mounting plate 154 includes the pair of lower cylindrical bosses 155 extending laterally inward from an inner facing surface thereof that define the axes of rotation of the fixed pivots 164, 166 and upon which bearings 145C, 145D are rotatably mounted. The stationary mounting plate 154 includes a pair of apertures 156 for receiving fasteners for mounting the mounting plate 154 and thus the motion converter 122 and the connected rotatable support shaft 114 to a conveyor system support frame. The stationary mounting plate 154 has a generally rectangular configuration except with a V-shaped central recessed portion 159 along its upper edge to provide clearance for upper end plate 152 when one end or the other end thereof rotates along with one of the forward and rearward shiftable upper pivots 160, 162 toward the mounting plate 154. A lower end bar 157 is mounted adjacent to the forward link 148 and rearward link 149 at laterally inner facing surfaces thereof via fasteners or screws 158, with the threaded shanks of the screws 158 extending through the bearings 145C, 145D and being received in threaded openings of the cylindrical bosses 155 of the stationary mounting plate 154.

As shown in FIGS. 10 and 11, rotation of the rotatable input member 142 by the rotatable support shaft 114 fixedly received therein causes the forward link 148 and rearward link 149 to rotate about forward and rearward fixed pivots 164, respectively. In particular, as shown in FIG. 10, when the rotatable input member 142 is rotated in a clockwise manner by rotatable support shaft 114, the rearward link 149 is pivoted about the rearward fixed pivot 166 in a counterclockwise manner and the forward link 148 is pivoted about the forward fixed pivot 164 in a counterclockwise manner, which in turn causes the rotatable input member 142 and the rotatable support shaft 114 to be shifted in a generally rearward or aft direction 25. Likewise, as shown in FIG. 11, when the rotatable input member 142 is rotated in a counterclockwise manner by rotatable support shaft 114, the rearward link 149 is pivoted about the rearward fixed pivot 166 in a clockwise manner and the forward link 148 is pivoted about the forward fixed pivot 164 in a clockwise manner, causing the rotatable input member 142 and the rotatable support shaft 114 to be shifted in a generally forward or fore direction 24. As the rotatable support shaft 114 is shifted generally forward or rearward along with the rotatable input member 142, both follow an arcuate path about pivot axis P. As a result, the pulley assembly 108 will also pivot about pivot axis P, causing the pulley 102 to extend non-orthogonally or obliquely to the belt travel direction 12 for directing the mistracking belt 10 back toward the correct belt travel path that is aligned along center line 14.

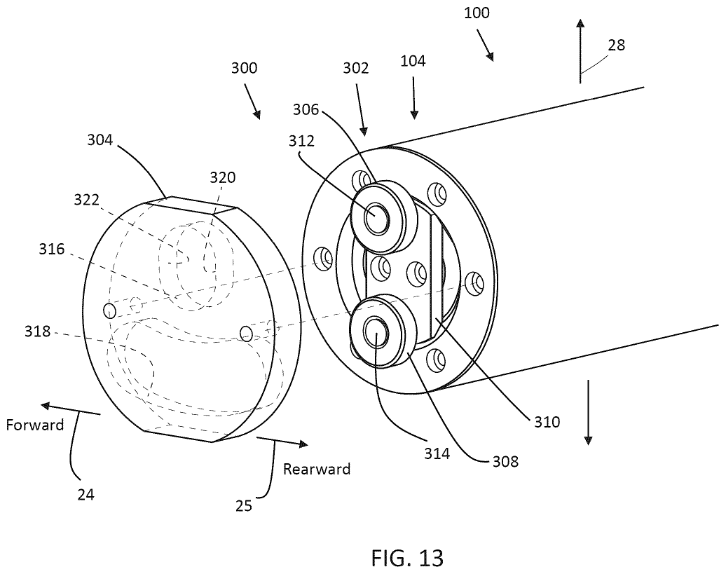

In another form shown in FIG. 13, a motion converter may be configured to allow the shiftable end portion 104 of the pulley 102 to pivot about pivot axis P for guiding the mistracking conveyor belt back toward a desired or correct travel path. In particular, the motion converter may be a cam mechanism 300 including a rotatable roller assembly 302 at the shiftable end portion 104 of the pulley 102 and a fixed end plate 304 configured for mounting to a conveyor system support frame for engagement with the roller assembly 302 and supporting the shiftable end portion 104 of the pulley assembly 108. The rotatable roller assembly 302 includes roller mounting plate 310 that is operably fixed relative to an end of a rotatable output of the transmission 126, such as the rotatable support shaft 114 so that rotation of the shaft 114 causes rotation of the roller mounting plate 310. The roller mounting plate 310 includes upper and lower cylindrical bosses 312, 314 that extend laterally outwardly therefrom and upon which upper and lower rollers 306, 308 are rotatably mounted. The fixed end plate 304 includes a laterally inward facing surface in which an upper vertically elongated recessed channel 316 and a lower arcuate recessed channel 318 that extends generally in the fore and aft directions 24, 25 are formed.

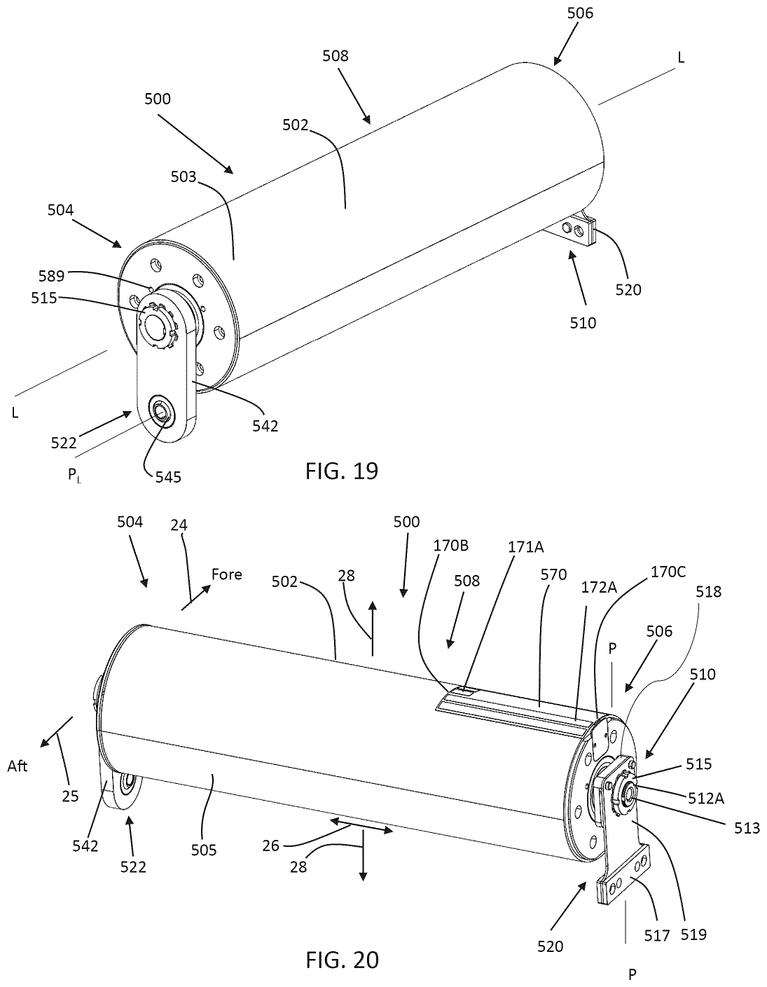

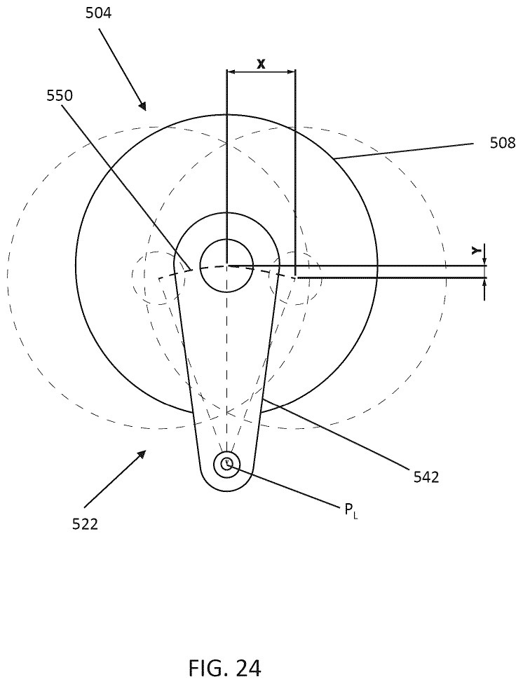

When assembled, the upper roller 306 is rotatably received in the upper vertically oriented channel 316 and the lower roller 308 is rotatably received in the lower arcuate channel 318. In the neutral position shown in FIG. 13, the upper and lower rollers 306, 308 are aligned in the vertical direction 28, parallel to the pivot axis P. To shift the shiftable end portion 104 of the pulley assembly 108 in a forward or downstream direction 24, the roller mounting plate 310 is rotated in a clockwise direction (from the perspective of FIG. 13) such that the upper roller 306 engages against a rear side wall 320 of the upper vertically oriented channel 316, while the lower roller 308 follows the arcuate path defined by the lower arcuate channel 318 in the forward direction 24. Conversely, to shift the shiftable end portion 104 of the pulley assembly 108 in a rearward or upstream direction 25, the roller mounting plate 310 is rotated in a counterclockwise direction such that the upper roller 306 engages against a forward side wall 322 of the upper vertically oriented channel 316, while the lower roller lower roller 308 follows the arcuate path defined generally by the lower arcuate channel 318 in the rearward direction 25. It will be recognized that because the lower roller 308 is allowed to move along the lower arcuate channel 318 and because the upper roller 306 is constrained against forward or rearward movement, the upper roller 306 will have to shift downward in the vertical direction 28 within the upper vertically oriented channel 316 when the lower roller 308 is shifted along the lower arcuate channel 318 in either direction from the neutral position, causing the shiftable end portion 104 to move generally in the fore or aft directions. In other forms, the shiftable connection could be a rack and pinion mechanism or a lever mechanism. For example, as shown in FIGS. 19 and 24, the lever mechanism includes a single link 542 that is fixedly connected at one end to the rotatable support shaft 114 so as to extend generally orthogonally therefrom and is rotatably or pivotally connected, such as with a ball joint, at an opposite, pivot end thereof to conveyor support frame structure such that rotation of the rotatable support shaft 114 about the longitudinal axis L causes the pivot end portion 106 of the pulley to rotate about the pivot end of the reaction arm along an arcuate path and consequently shift the pivot end portion 106 in the fore or aft direction 24, 25.

The belt tracker 100 may include one or more sensors for sensing conveyor belt portion information, such as the presence and/or position of a portion of the conveyor belt, such as an outer or lateral edge 20 of the belt 10. The sensor or sensors can be integrated with the pulley assembly 108 of the belt tracker 100, and more specifically the pulley 102 thereof. As shown in FIGS. 3, 4A and 7A, a belt position sensor assembly 170 may be a non-contact sensor, such as a capacitive sensor, is mounted on a belt facing surface 105 of the rotatable pulley 102, such as at the shiftable end portion 104 of the pulley 102. In other embodiments, the belt position sensor assembly 170 may be mounted at the pivot end portion 106 of the pulley. The belt position sensor assembly 170 is oriented on the surface 105 of the pulley 102 such that the belt edge 20 is positioned over the sensor assembly intermittently as the pulley 102 rotates about its longitudinal axis L. The belt position sensor assembly 170 may be fixedly mounted underneath the pulley lagging 103, such as by an adhesive, fasteners, or the like, and optionally a shrink tube protective layer underneath the pulley lagging 103 so as to protect the sensor assembly 170 from contact with the belt 10, debris, liquids and other foreign materials that could cause damage or interfere with the operation of the sensor assembly 170. Due to its mounting to the rotatable pulley 102, the belt position sensor assembly 170 is configured to rotate together with the pulley 102 as the belt travels over the pulley 102 in contact with the pulley lagging 103 thereof. The belt position sensor assembly 170 is sized and configured to extend over only a portion of the circumference of the pulley 102 such that the belt position sensor assembly 170 detects the presence and the position of the belt 10 momentarily with every revolution of the pulley 102.

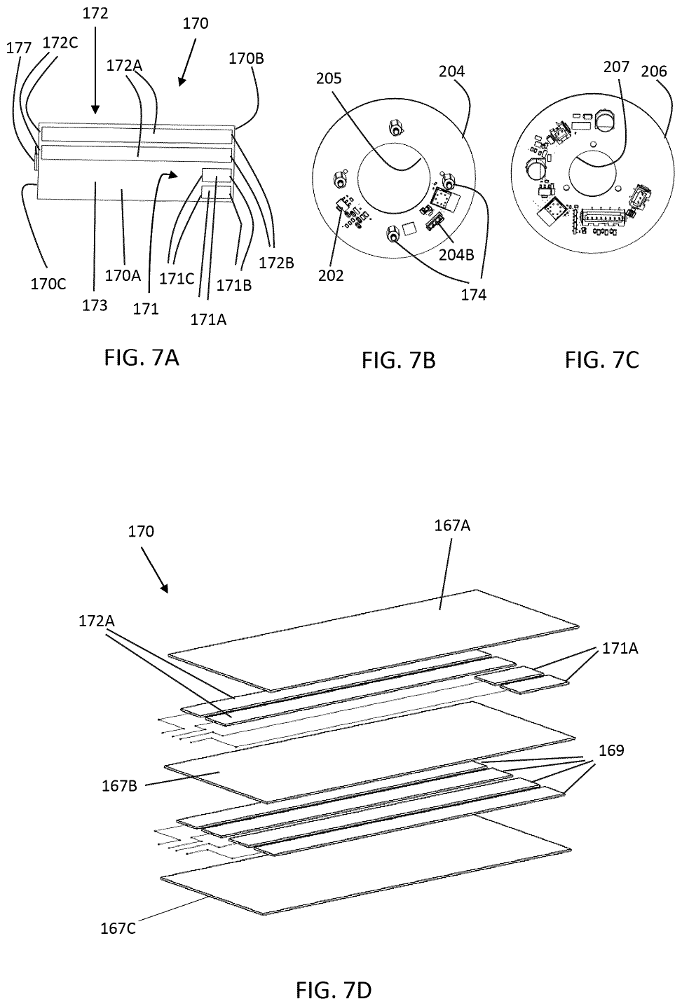

Referring now to FIGS. 7A and 7D, the belt position sensor assembly 170 has a generally rectangular body 170A, such as a flexible printed circuit board (PCB), that allows it to conform to the arcuate surface of the annular or cylindrical pulley body 102A. The belt position sensor assembly 170 includes a plurality of capacitive sensors formed on or integrated with the PCB body 170A, including a belt reference sensor 171 and a belt position sensor 172. In some embodiments, the PCB body 170A may be provided with additional sensors, such as a reference environment sensor for sensing environmental factors, such as the lagging 103 and foreign materials and/or debris stuck thereto, rather than the belt 10. As shown in FIG. 7D, the PCB body 170A includes a number of layers, including from top to bottom, a top insulator layer 167A, reference sensor electrodes 171A and belt position sensor electrodes 172A, an intermediate sensor layer 167B, shields 169, and a bottom insulator layer 167C. As will be described in further detail hereinafter, a ribbon electrical connector portion 177 for electrically connecting the belt position sensor assembly 170 to the rotatable control circuitry portion 204 is omitted in FIG. 7D for clarity.

The belt reference sensor 171 includes a pair of adjacent shorter reference sensor electrodes 171A and a pair of shields 169. The belt position sensor 172 similarly includes a pair of longer adjacent belt position sensor electrodes 172A and a pair of shields 169. In both sensors 171, 172, the shields 169 are operable to focus the sensing direction above the generally rectangular body 170A toward the belt 10 and to provide a barrier from interference underneath the electrodes 171A, 172A. Each electrode 171A, 172A has an elongate strip configuration with the electrodes being arranged in parallel longitudinally extending rows. Each of the sensor electrodes 171A, 172A have one end 171B, 172B at a laterally inner edge 170B of the rectangular body 170A and extend laterally outwardly towards the opposite, laterally outer edge 170C thereof. As shown in FIG. 3, the belt position sensor assembly 170 is mounted at the shiftable end portion 104 of the pulley 102 with the reference sensor electrodes 171A and belt position sensor electrodes 172A extending parallel to the longitudinal axis L of the pulley 102. The belt position sensor assembly 170 is sized and configured such that the belt 10 will be positioned over the shorter reference sensor electrodes 171A, which only extend a short distance away from the body laterally inner edge 170B to their other opposite ends 171C, during normal operation of the belt 10 even when the belt is mistracking towards pivot end portion 106 away from the shiftable end portion 104 on which the belt position sensor assembly 170 is mounted. By contrast, the longer belt position sensor electrodes 172A extend proximately to the laterally outer edge 170C of the generally rectangular body 170A so that the other opposite ends 172C are at or closely adjacent to the laterally outermost extent of the shiftable end portion 104 at the end of the pulley 102 to allow the edge 20 of the belt 10 to be detected when the belt is mistracking towards the shiftable end portion 104. When the belt 10 is tracking correctly, the belt 10 will be able to completely cover the reference sensor electrodes 171A such that the belt edge 20 will be positioned laterally outwardly from the laterally outer ends 171C of the reference sensor electrodes 171A and laterally inwardly from the laterally outer ends 172C of the belt position sensor electrodes 172A where the belt edge 20 will be further positioned generally above an intermediate portion of the belt position sensor electrodes 172A, as shown in FIG. 3.

The belt reference sensor 171 and the belt position sensor 172 are each driven with an excitation signal, which will change due to changing capacitance proximate to the sensors. Accordingly, when the belt 10 is present over the belt reference sensor 171 (which will typically occur intermittently with each revolution of the pulley 102) and at least a portion of the belt position sensor 172, each sensor 171, 172 will detect an increased capacitance and output a signal proportional to the capacitance detected. The belt reference sensor 171 outputs a reference signal that accounts for incremental unit measurements of the belt position sensor 172 that is generally independent of the belt position (assuming the belt edge 20 is positioned beyond the electrode ends 171C.) The belt position sensor 172 outputs a signal proportional to the lateral position of the belt edge 20 relative to the belt position sensor electrodes 172A such that the more of the belt position sensor electrodes 172A that are covered by the belt 10, the higher the amplitude of the signal that is output thereby. Accordingly, if the belt 10 is mistracking towards shiftable end portion 104, the belt edge 20 will be positioned nearer to the laterally outer ends 172C of the belt position sensor electrodes 172A such that the belt 10 is covering the majority of the belt position sensor electrodes 172A. This results in a higher capacitance detected by the belt position sensor electrodes 172A relative to the capacitance detected thereby when the belt 10 is tracking properly, and thus a signal with a higher amplitude is output by the belt position sensor 172. Conversely, if the belt 10 is mistracking towards the pivot end portion 106 of the pulley, the belt edge 20 will be positioned nearer to but not beyond the laterally inner ends 172B of the belt position sensor electrodes 172A such that the belt 10 is covering less of the belt position sensor 172 than when the belt is tracking properly, resulting in a relatively lower capacitance detected and a signal with a lower amplitude output by the belt position sensor 172.

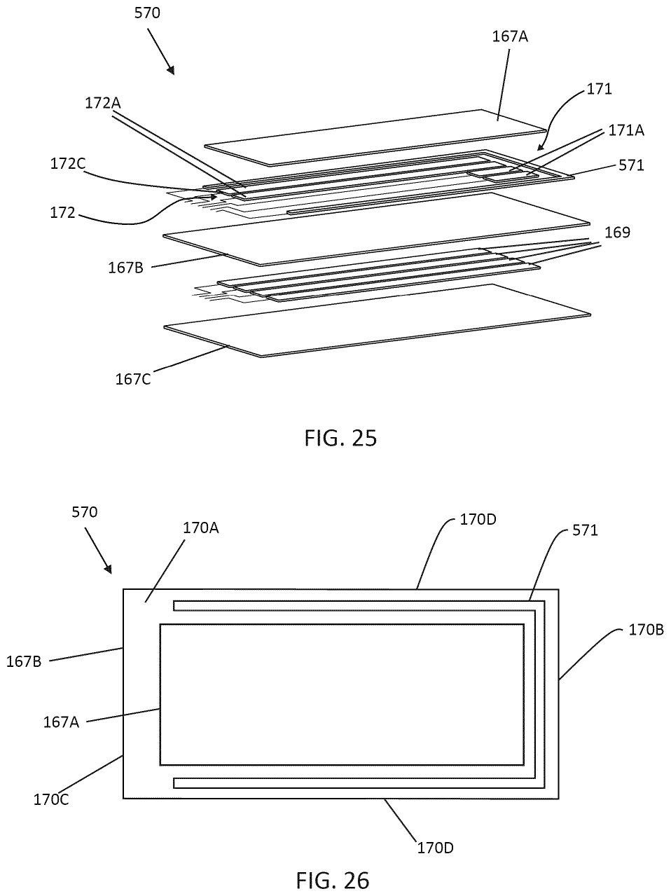

In an alternative embodiment, as shown in FIGS. 25 and 26, the belt position sensor assembly 570, which is similar in structure and function to belt position sensor assembly 170, includes an electrically conductive border 571 that extends about the reference sensor electrodes 171A and belt position sensor electrodes 172A and is connected to ground to provide static charge protection to the belt reference sensor 171 and belt position sensor 172. The conductive border 571 has a “U” shape that extends about the belt reference sensor 171 and belt position sensor 172 on three sides, including laterally inner edge 170B and opposing elongate sides 170D of the sensor assembly 570. As shown in FIG. 26, the conductive border 571 is positioned on the intermediate sensor layer 167B and is sized to extend about a periphery of the top insulator layer 167A on three sides in a similar manner.

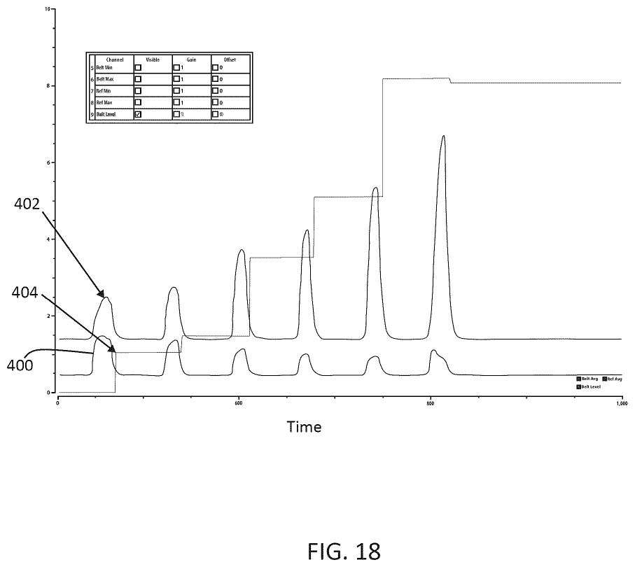

Now referring to FIG. 18, a graph illustrating an exemplary output of the belt reference sensor 171 and belt position sensor 172 of the belt position sensor assembly 170, 570 over a period of time is provided. The graph shows a reference signal 400 output from the belt reference sensor 171 corresponding with a capacitance detected thereby, a belt position signal 402 output from the belt position sensor 172 corresponding with a capacitance detected thereby, and a computed belt position 404 corresponding to the position of the belt 10 relative to the belt position sensor 172 superimposed over the reference signal 400 and belt position signals 402. To illustrate the operation of the belt position sensor assembly 170, the conveyor belt 10 was gradually shifted laterally along the lateral direction 26 from right to left (relative to the orientation shown in FIG. 3) from a mistracking position with the belt centerline 13 closer to the pivot end portion 106 to a mistracking position with the belt centerline 13 closer to the shiftable end portion 104 while the pulley 102 rotates along with the belt 10 moving in the belt travel direction 12. For this demonstration, the electric motor 124 was deactivated such that no attempt was made to steer the belt 10 back to a correct travel path.

Each pulse of reference signal 400 and belt position signal 402 represents the belt 10 passing over the belt reference sensor 171 and the belt position sensor 172, respectively, and the horizontal flat portions of the signals 400, 402 between the pulses represents the belt position sensor assembly 170 rotating away from the belt 10 with each revolution of the pulley 102. The amplitude of the pulses of belt position signal 402 represent how much of the belt position sensor electrodes 172A are covered by the belt 10 and the increasing amplitude of each pulse corresponds to the belt edge 20 shifting further to the left (in lateral direction 26 relative to the orientation shown in FIG. 3) toward the end of the shiftable end portion 104 of the pulley 102. Accordingly, the computed belt position 404 increases in amplitude with the increasing amplitude of the belt position signal 402. The computed belt position 404 may be determined using the following equation:

$$Position = {h}_{RP} \frac{{C}_{position} - {C}_{position} ( 0 )}{{C}_{RP} - {C}_{RE}}$$

Wherein h_{RP}=the unit position of the reference sensor (typically 1);
Cₚₒₛᵢₜᵢₒₙ=capacitance of the belt position sensor 172;
Cₚₒₛᵢₜᵢₒₙ(0)=capacitance of the belt position sensor 172 when belt 10 is not present;
C_{RP}=capacitance of the belt reference sensor 171;
C_{RE}=capacitance of a reference environmental sensor (if present, otherwise value is zero).

A lower computed belt position 404, such as shown with the peak pulse values toward the left side of the graph of FIG. 18 corresponds with the belt 10 mistracking toward the pivot end portion 106 of the pulley such as shown in FIG. 15. A computed belt position 404 towards the middle of the range of peak pulse values corresponds with the belt 10 tracking generally properly such that the belt centerline 13 is centered on the pulley 102 between the end portions 104, 106 as shown in FIG. 3. A high computed belt position 404, such as shown with the peak pulse values toward the right side of the graph, corresponds with the belt 10 mistracking towards shiftable end portion 104, as shown in FIG. 14. The signals output from the belt position sensor 172 and the computed belt position 404 can be used by a control system 200 of the belt tracking apparatus 100 to control the actuator 124, such as using a closed-loop, proportional or proportional-integral-derivative (PID) control algorithm. For example, the control system 200 will control the actuator 124 to rotate the rotatable support shaft 114 in response to the difference between the detected position of the belt edge 20 and the desired position of the belt edge 20 to automatically shift the position of shiftable end portion 104 generally upstream or downstream to steer the belt 10 when it is mistracking back to the correct travel path.

Advantageously, the belt tracker 100 is operable to track the belt for conveyor belts that are reversable. If the direction of movement of the belt is reversed from an initial or primary belt travel direction 12, the belt position sensor assembly 170, communication modules 210, 218, and/or a rotary encoder 222 can detect the change and the control system 200 can reverse the operation of the actuator 124, e.g., change the actuation direction of the actuator 124, such as by changing a clockwise rotation of the drive shaft 124A to counterclockwise and vice versa, to compensate for the change in the belt travel direction so that the shiftable end portion 104 is shifted in the correct upstream or downstream direction to steer the belt 10. For example, if the belt 10 is mistracking towards the shiftable end portion 104 of the pulley 102 and the belt is traveling in the belt travel direction 12, the actuator 124 shifts the pulley 102 in the forward or downstream direction 24 to direct the belt 10 back towards a centered position on the pulley 102. However, when the belt travel direction 12 is reversed, the downstream direction is then also reversed relative to the initial belt travel direction 12, and the pulley 102 will need to be shifted in the new downstream direction, i.e. the aft or rearward direction 25, to steer the belt 10 towards a centered position on the pulley 102.

Because of the arrangement of the reference sensor electrodes 171A and the belt position sensor electrodes 172A in spaced, parallel rows that extend axially or longitudinally and transversely to the direction of rotation of the pulley 102, one of the belt reference sensor 171 and the belt position sensor 172 will detect the presence of the belt 10 before the other, resulting in a slight difference in phase between the signals. For example, as shown in FIG. 3, the belt position sensor 172 will travel under the belt 10 just before the belt reference sensor 171 when the belt is traveling in belt travel direction 12. Conversely, in the graph of FIG. 18, the peaks of the belt position signal 402 slightly trail the corresponding peaks of the reference signal 400. This means that the pulley 102 was rotating in the opposite direction from the direction it rolls with belt 10 travelling in the belt travel direction 12, which generates the signals 400, 402 shown in the graph of FIG. 18. Accordingly, the control system 200 can use this difference in phase between reference signal 400 and belt position signal 402 to determine the direction of rotation of the pulley 102 and therefore the belt travel direction. The control system 200 can then control the actuator 124 in accordance with the detected belt travel direction and can immediately account for reversals in the belt travel direction. Thus, by mounting the belt position sensor assembly 170 on the surface 105 of the pulley 102, the direction of rotation of the pulley and belt travel direction 12 advantageously can be detected, which is not possible with conventional belt position sensors, such as those mounted external to the belt tracker adjacent to the belt edge 20. Although the belt position sensor assembly 170 is shown positioned at shiftable end portion 104 of the pulley 102, the belt position sensor assembly 170 may also be positioned at or adjacent to pivot end portion 106, or a belt position sensor assembly 170 may be positioned at or adjacent to each end portion 104, 106.

In another embodiment, a sensor for detecting the presence and/or position of the belt may be mounted inside the rotatable pulley 102 such that the sensor does not rotate together with the pulley. In this form, the belt position sensor is capable of detecting the position of the belt 10 continuously, rather than momentarily with each revolution of the pulley 102. In other forms, the belt position sensor may be mounted externally to the rotatable pulley 102, such as adjacent one lateral edge 20 of the belt in a downstream and/or upstream location near the belt tracker 100.

The control system 200 is configured to control the position of the pulley 102 relative to the belt 10 in response to information detected by the belt position sensor assembly 170 and/or other sensors 224, such as the belt position 404, belt speed and direction of travel. The control system 200 includes control circuitry or electronics 202, including the belt position sensor assembly 170. The control circuitry 202 may be divided between multiple locations internal and/or external to the pulley 102, such as in a module mounted adjacent to the belt tracker 100. As shown in FIGS. 6-8, at least an internal portion 203 of the control circuitry 202 of the control system 200 is mounted within the internal space 109 pulley body 102A. In embodiments wherein the belt position sensor assembly 170 is mounted to the pulley 102 such that it rotates along with the pulley, at least a portion 204 of the internal portion 203 of the control circuitry 202 that is operably electrically connected to the belt position sensor assembly 170 is also configured to rotate together with the belt position sensor assembly 170 and the pulley 102, such as by being fixed to the pulley. This rotatably mounted portion 204 of the control electronics includes processing circuitry 214, including a capacitance to digital converter configured to obtain and process signals from the belt position sensor assembly 170 into digital data for further processing, such as processing the signals for controlling the actuator 124 and transferring the data or signals to another portion of the control circuitry 202 or to an external computing device via a communication module or modules 210.

Another portion 206 of the control circuitry 202 is mounted so as to rotate along with the rotatable support shaft 114. In this form, the portion 206 of the control electronics is partially rotatable in that the portion 206 is shifted or rotated in a limited manner when the actuator 124 shifts the partially rotatable support shaft 114 to move the shiftable end portion 104 of the pulley 102 upstream or downstream. In one form, the partially rotatable support shaft 114 and partially rotatable control circuitry 206 mounted thereto are configured to rotate less than an entire revolution in either the clockwise or counterclockwise directions to shift the shiftable end portion 104 of the pulley 102 through its entire range of general upstream and downstream movement. For example, the partially rotatable support shaft 114 and the partially rotatable control circuitry 206 mounted thereto may be shifted by the actuator 124 approximately 30 degrees in either direction. In other embodiments, such as the belt tracking apparatus 500 of FIGS. 19-24, the partially rotatable control circuitry portion 206 or another portion of the control circuitry 202 may be mounted within the pulley 102 in a stationary, non-rotatable manner near the pivot end portion 106 of the pulley, such as on or about the stationary support shaft 512. Accordingly, the partially rotatable control circuitry portion 206 referred to herein in some embodiments may be a stationary control circuitry portion but may otherwise have the same or similar structure and the same or similar function as the partially rotatable control circuitry portion 206 described herein. This mounting location can be preferable if the belt position sensor assembly 170, 570 is mounted to the pulley 102 at the pivot end portion 106 thereof, as shown in FIG. 20.

The control electronics 202 includes processing circuitry 214, 226 which may include discrete or integrated logic, and/or one or more state machines, processors (suitably programmed) and/or field programmable gate arrays (or combinations thereof); indeed, any circuitry (for example, discrete or integrated logic, state machine(s), special or general purpose processor(s) (suitably programmed) and/or field programmable gate array(s) (or combinations thereof)). In operation, the processing circuitry 214, 226 may perform or execute one or more applications, routines, programs and/or data structures that implement particular methods, techniques, tasks or operations described and illustrated herein. The functionality of the applications, routines or programs may be combined or distributed. Further, the applications, routines or programs may be implemented by the processing circuitry using any programming language whether now known or later developed, including, for example, assembly, FORTRAN, C, C++, and BASIC, whether compiled or uncompiled code; all of which are intended to fall within the scope of the present invention.

The processing circuitry 214, 226 is communicatively coupled to one or more sensors, including the belt position sensor assembly 170 and a rotary encoder 222 for detecting the position, direction of rotation, and/or speed of the pulley 102 and the rotatable support shaft 114, and any additional sensors 224 for processing signals therefrom, including analog to digital conversion thereof. Other sensors 224 can include, without limitation, accelerometers and temperature sensors, which may be used for diagnostic purposes, for example. The processing circuitry 214, 226 is also configured for preparing the signals for transfer and transmission of the signals or data to other devices or other components of the control electronics 202 associated with the belt tracker 100, and controlling the actuator 124 based on the signals or data acquired from the belt position sensor assembly 170, rotary encoder 222 and/or other additional sensors 224. The processing circuitry 214, 226 is communicatively connected to memory modules 208, 228, which may be non-transitory computer readable memory, such as random-access memory (RAM), solid state memory, or magnetic disc-based memory. Signals or data from the sensors 224, including the belt position sensor assembly 170, is transmitted to the processing circuitry 214, 226, which writes the received data to the memory module 228 and/or 208.

The processing circuitry 214, 226 of the rotatable control circuitry portion 204 and partially rotatable control circuitry portion 206 are communicatively connected via printed conductive lead lines to respective communication modules 210, 218 that are configured to communicate with each other and transfer conveyor belt portion information or other data therebetween wirelessly within the internal space 109 of the pulley 102 via a short-range communication protocol, such as Bluetooth or an optical wireless communication protocol (OWC), such as Li-Fi (light fidelity). For example, the communication modules 210, 218 may include an LED transmitter for transmitting data optically and an optical receiver for receiving and processing the optically transmitted data. In such an embodiment, the communication modules 210, 218 may implement a rotary encoder 222 and/or are operable to provide an encoder function to provide the control system 200 with information regarding the speed, position, and/or direction of rotation of the rotatable control circuitry portion 204 and the pulley 102. For example, the communication module 210, 218 operating as the receiver can detect each time the LED transmitter is aligned with the receiver, such as when the received signal amplitude is at its peak, and can determine how frequently the transmitter passes the receiver to determine the speed of the pulley 102 and of the belt 10. The communication modules 210, 218 may also be configured to communicate in a wireless manner using any of a variety of communication protocols, such as via Bluetooth or wi-fi, with computing devices associated with the conveyor system 30, as well as external computing devices, such as smartphones, tablets, laptops, desktops, servers and cloud computing systems. The communication modules 210, 218 may be configured to communicate via one or more networks, such as a cellular phone network (e.g., 3G, 4G, 5G, etc.) and/or the internet. The communication module 218 of partially rotatable or stationary control circuitry portion 206 may also be configured to communicate in a wired manner using any variety of communication protocols.

In some embodiments, the control system 200 is configured to be in operable communication with and monitored by a conveyor monitoring system, such as the various systems disclosed in U.S. Pat. No. 10,836,585, which is incorporated by reference herein in its entirety. Such a conveyor monitoring system monitors other devices and sensors associated with ancillary devices of the conveyor system, such as such as splices and splice fasteners, belt scrapers, idler rollers, belt trackers, such as the belt tracking apparatus 100, and/or impact beds. The one or more devices and sensors are associated with the ancillary devices in a number of approaches, such as being integrated with the ancillary devices, mounted to or adjacent to the ancillary devices, mounted to support structure for the ancillary devices and/or mounted to frame members of the structure supporting the conveyor belt proximate the ancillary devices.

The communication modules 210, 218 may utilize any of a variety of communication protocols. For example, communication modules 210, 218 may use infrastructure protocols such as 6LowPAn, IPv4/Ipv6, RPL, QUIC, Aeron, uIP, DTLS, ROLL/RPL, NanoIP, CNN, and TSMP; identification protocols such as EPC, uCode, Ipv6, and URIs; communication/transport protocols such as Wifi, Bluetooth®, DigiMesh, ANT, NFC, WirelessHart, IEEE 802.15.4, Zigbee, EnOcean, WiMax, and LPWAN; discovery protocols such as Physical Web, mDNS, HyperCat, UpnP, and DNS-SD; Data protocols such as MQTT, MQTT-SN, Mosquitto, IMB MessageSight, STOMP, XMPP, XMPP-IoT, CoAP, AMQP, Websocket and Node; device management protocols such as TR-069 and OMA-DM; semantic JSON-LD and Web Thing Model; and/or multi-layer frame work protocols such as Alljoyn, IoTivity, Weave, and Homekit.

The stationary or partially rotatable portion 206 of the control circuitry 202 is configured to provide power to the rotatable portion 204 of the control circuitry 202, including the belt position sensor assembly 170. In one form, power may be transmitted in a wireless manner, such as by induction. In other forms, power may be transmitted via capacitive or photoelectric transfer, for example. For transmitting power via induction, the stationary or partially rotatable portion 206 of the control circuitry 202 includes power supply circuitry 220 including a transmitter with an induction coil for transmitting an electromagnetic field and the rotatable portion 204 of the control circuitry 202 may include power supply circuitry 216 including a corresponding receiver with a corresponding induction coil for receiving the electromagnetic field and converting it to an electric current. The power supply circuitry 220 of the stationary or partially rotatable control circuitry portion or portions 206 includes one or more DC power supplies for supplying appropriate power to the control circuitry 202 and to the actuator 124. In other embodiments, the power supply circuitry 220 of the stationary or partially rotatable control circuitry portion 206 includes one or more batteries for supplying appropriate power to the control circuitry 202. The power supply circuitry 220 is located internally within the pulley 102 and is configured to be connected to a power source 212, such as an 110-230 V AC power source located external to the pulley 102. In other embodiments, the power supply circuitry 220 is located externally to the pulley 102. In another form, the control circuitry 202 may be powered by an energy harvesting device, such as electromagnetic generator that is powered by rotation of the pulley 102.

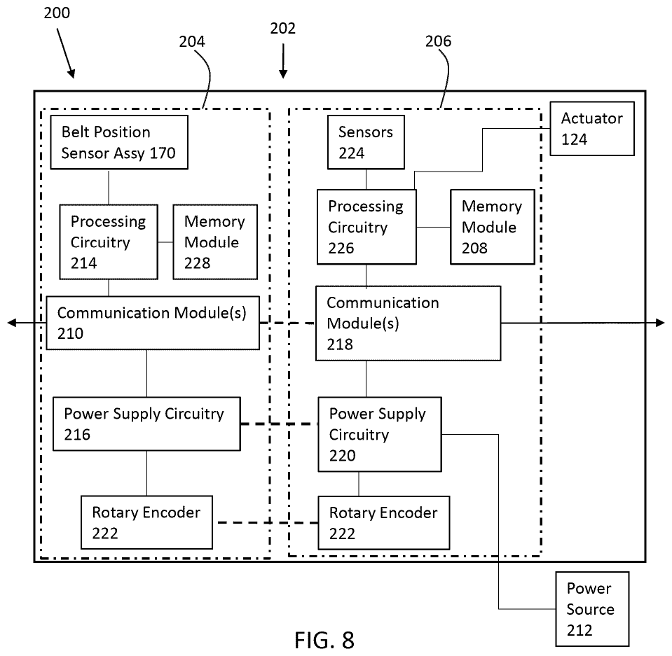

To facilitate wireless power and data transmission, the rotatable and the stationary or partially rotatable control circuitry portions 204, 206 are positioned directly adjacent to one another within the internal space 109 of the rotating pulley 102, as shown in FIGS. 6A and 6B. As shown in FIGS. 6A, 6B and 7A-C, the rotatable and partially rotatable electronics portions 204, 206 each may be embodied as printed circuit boards (PCBs) having an annular configuration with a central through opening 205, 207 for allowing the rotatable support shaft 114 to extend therethrough. The rotatable control circuitry portion 204 is operably connected to the pulley 102 to rotate therewith. Although the rotatable control circuitry 206 and the stationary or partially rotatable control circuitry portion 204 are embodied as two separate PCBS, in other embodiments, the control circuitry 202 may be divided into more than two separate portions. In particular, various components of the control circuitry 202 shown in FIG. 8 may be located at different physical locations, such as different circuit boards, other than as shown in FIG. 8. For example, sensors 224 shown as being located on stationary or partially rotatable control circuitry portion 206 may be located elsewhere within the pulley assembly 108, or may be located remotely therefrom.

In particular, the rotatable control circuitry portion 204 is mounted via post members 174 having threaded ends that are received in corresponding threaded openings 179 in a laterally inner facing surface of end plate 175A. Accordingly, the rotatable control circuitry portion 204 is spaced from the laterally inner facing side of annular compression member 180 with sufficient clearance for the control circuitry components 202, such as communication module 210, processing circuitry 214, memory module 228, and power supply circuitry 216, on the laterally outer facing side of the rotatable control circuitry portion 204 circuit board 204A, as shown in FIG. 6A. In other embodiments, such as the belt tracker 500 shown in FIGS. 19-24, the rotatable control circuitry portion 204 may be mounted to end plate 175B, 575B at the pivot end portion 106, 506 of the pulley assembly 108, 508 in a similar manner as shown in FIGS. 6A and 6B and described herein. In such embodiments, the partially rotatable control circuitry portion 206 may be mounted in a stationary manner to the stationary support shaft 112 adjacent to the rotatable control circuitry portion 204 with a gap therebetween to allow rotatable control circuitry portion 204 to freely rotate while facilitating wireless data and power transfer therebetween.

An opening or channel 176 is formed in a periphery of the end plate 175A and leads to an interior space 109 of the pulley 102 so that the ribbon electrical connector portion 177 extends from an outer lateral end 170C of the belt position sensor assembly 170, in electrical communication therewith, external of the pulley interior space 109 to pass therethrough via the channel 176 and connect with a corresponding connector 204B projecting from the rotatable control circuitry portion 204. The partially rotatable control circuitry portion 206 extends about rotatable support shaft 114 and is fixedly connected via fasteners to an annular collar member 178 that is fixedly mounted to the shaft 114 so that the partially rotatable control circuitry portion 206 rotates therewith. The partially rotatable control circuitry portion 206 is positioned on rotatable support shaft 114 so that a gap is present between the partially rotatable control circuitry portion 206 and rotatable control circuitry portion 204 to allow for relative rotational movement about the longitudinal axis L therebetween.

The circuit boards 204A, 206A of the rotatable and partially rotatable control circuitry portions 204, 206 are mounted so as to extend generally parallel to one another and transverse to the longitudinal axis L to allow rotation therebetween, facilitate data and power transfer, and allow for the detection of the relative movement therebetween. In particular, the relative rotary angular orientation, direction of movement, and/or velocity of the separate electronics portions 204, 206 relative to one another, alone or together with information from the belt position sensor assembly 170, including the presence, position and frequency of detection of the belt 10, can be used to measure, detect, derive and/or predict various information about the belt 10, conveyor system 30 and the belt tracker 100 itself. For example, signals or data from the belt position sensor assembly 170 can be utilized by the control system 200 to determine whether the conveyor belt 10 is present and the position of the belt edge 20 on the pulley 102, whether the pulley 102 is rotating, the direction it is rotating, the speed with which it is rotating, whether the belt 10 is positioned at the top (as shown in FIG. 3) or the bottom of the pulley assembly 108, and whether the belt 10 is being redirected in the correct direction in response to fore or aft movement of the pulley 102. This sensed information can be used by the control system 200 to determine various other information, such as whether the belt 10 is moving, its direction, and its velocity. In particular, the speed of the pulley 102 can be determined by calculating the time elapsed between each detection of the belt 10 by the belt reference sensor 171 and/or belt position sensor 172, which corresponds with a single revolution of the pulley 102. The number of revolutions of the pulley 102 per minute (RPM) can be converted to a belt speed by multiplying the RPM of the pulley 102 by the circumference of the pulley 102, i.e., the diameter of the pulley assembly 108 multiplied by Π (3.14159). Whether the belt 10 is positioned at the top or bottom of the pulley assembly 108 can be determined by comparing the timing of the when the belt 10 is detected by the belt position sensor assembly 170 compared to the angular position of the rotatable control circuitry portion 204 relative to the partially rotatable control circuitry portion 206 and/or the rotatable support shaft 114 determined by the rotary encoder 222. Depending on the top or bottom position of the belt relative to the pulley assembly 108, the control system 200 will control the actuator 124 accordingly.

In particular, the pulley 102 will rotate in opposite directions depending on whether the belt 10 is positioned above or below the pulley assembly 108. For example, if the belt 10 is positioned above the pulley assembly 108 as shown in FIGS. 3 and 14 and the belt 10 is traveling in the belt travel direction 12, the pulley 102 rotates in a counterclockwise direction as viewed from the left side of the belt tracker 100. Accordingly, to redirect the belt 10 mistracking toward the shiftable end portion 104 of the pulley 102, the pulley 102 must be shifted in the forward 24 or downstream direction as shown in FIG. 14. If the belt 10 were instead positioned below the pulley assembly 108 and traveling in the same belt travel direction 12, the pulley 102 would rotate in a clockwise direction. Despite the different direction of rotation of the pulley 102, the pulley 102 must be shifted in the same forward 24 or downstream direction as shown in FIG. 14 to redirect the belt 10 when it is mistracking toward the shiftable end portion 104. Accordingly, to accurately determine the direction of travel 12 of the belt 10, the control system 200 determines whether the belt 10 is positioned above or below the pulley assembly 108 as well as the direction of rotation of the pulley 102. The pulley assembly 108 can then be shifted by the actuator 124 in the appropriate fore or aft direction 24, 25 relative to the direction of travel 12 of the belt 10 to shift the mistracking belt 10 back toward the correct belt travel path that is aligned along center line 14.

The control system 200 can also detect or derive other information via the rotary encoder 222 connected to the rotatable control circuitry portion 204 and the partially rotatable control circuitry portion 206 including the relative angular orientation or position, speed, and direction of rotation between the fully rotatable and partially rotatable control circuitry portions 204, 206. In addition, the rotary encoder 222 can be used to determine the position of shiftable end portion 104 of the pulley 102. For example, if the stationary support shaft 112 is rotated to its maximum extent, such as 30 degrees in the clockwise or counterclockwise position, the rotary encoder 222 can detect the change in angular position of the partially rotatable control circuitry portion 206 relative to the fully rotatable control circuitry portion 204 and the corresponding movement of the shiftable end portion 104 upstream or downstream. In addition, a separate switch or sensor 224 can be utilized to detect when the pulley 102 is in a home position, such as the neutral position shown in FIG. 3. The switch or sensor 224 in one form is operably connected to the transmission 126, such as the output shaft 140 thereof, or to the rotatable support shaft 114. For example, the switch or sensor 224 may be implemented as a contact or non-contact switch, such as an optical switch, that detects when the output shaft 140 and/or the rotatable support shaft 114 is oriented in the home position, i.e., in the middle of its range of motion. The control system 200 is configured to cause the actuator 124 to automatically return the pulley 102 to the home position upon start up so that the home position can serve as a point of reference for the control system 200 to accurately determine the position of the pulley 102, which allows for accurate control of the movement of the pulley 102. In one embodiment, the switch or sensor 224 is in an “on” state when the output shaft 140 and rotatable support shaft 114 are rotated clockwise from the home position and is in an “off” state when the output shaft 140 and rotatable support shaft 114 are rotated counterclockwise from the home position. In this configuration, the home position is detected by the control system 200 when the state of the switch or sensor 224 changes from on to off or from off to on.

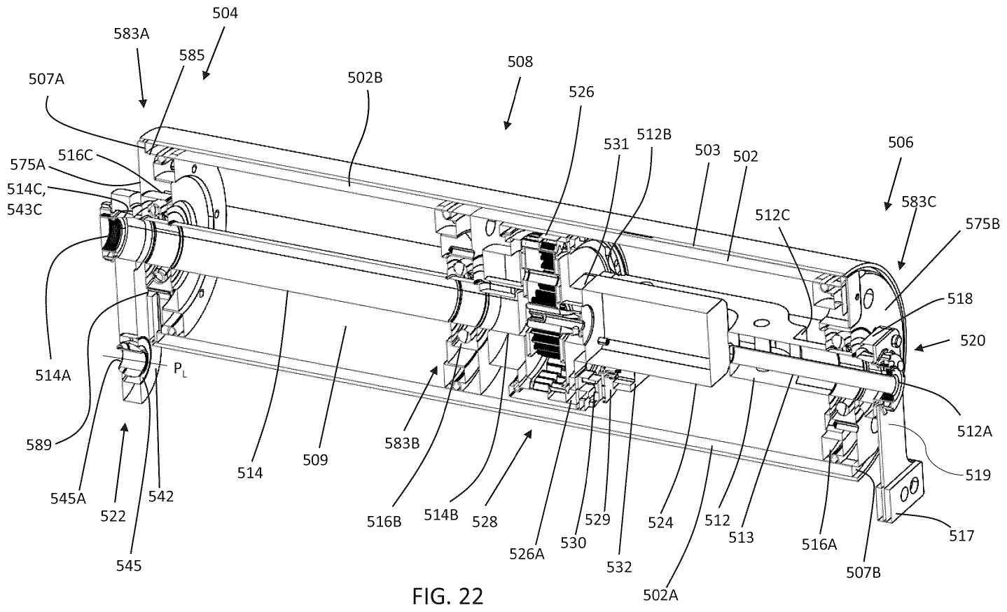

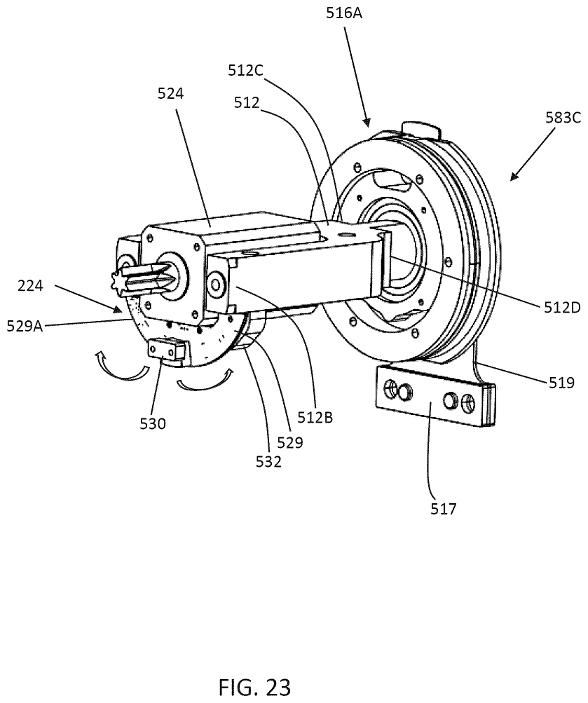

In another form shown in FIGS. 22 and 23, the sensor 224 may be a position sensor, such as motion-sensing inductive sensor. In one form, the motion-sensing inductive sensor is implemented by a magnetic field interface integrated circuit 529 and a target member 530. The magnetic field interface integrated circuit 529 is formed on an arcuate PCB 529A that is mounted to extend transversely across and underneath the spaced apart ends of the forked laterally inner end portion 512B of the stationary support shaft 512 via a mounting bracket 532. The target member 530 is of a metallic material and is mounted to a rotatable portion of the support assembly 510, such as a rotatable portion of a housing 526A of the transmission 526 facing and directly adjacent to arcuate PCB 529A, such that the target member 530 rotates along with the transmission housing 526A along a predetermined range of motion, such as plus or minus 30 degrees, as the actuator 524 rotates the transmission housing 526A and attached rotatable support shaft 514. The magnetic field interface integrated circuit 529 includes a transmission coil extending along an arcuate path along the PCB 529A corresponding to the range of motion of the target member 530, to generate a magnetic field that induces eddy currents in the metallic target member 530. The target member 530 changes the magnetic field generated by the transmission coil and this change is sensed by a receiver coil or coils that also extend along a length of the PCB 529A corresponding to the range of motion of the target member 530. Advantageously, the magnetic field interface integrated circuit 529 is operable to detect the position of the target member 530 at any position along its range of motion such that the control system 200 can determine the rotational displacement of the drive shaft 524A of the actuator 524, from which a position of the shiftable end portion of the pulley assembly 508 can be determined by the control system 200. In addition, the magnetic field interface integrated circuit 529 does not require the target member 530 to be returned to a home position corresponding to the neutral position of the pulley assembly 508 to accurately detect the position of the target member 530, such as can be necessary with other methods of determining the orientation of the drive shaft 524A or the shiftable end portion 504 of the pulley assembly 508 when the power to the belt tracker 500 is cycled.

Advantageously, the effect of environmental factors on the accuracy of the belt position sensor assembly 170, such as fouling of the pulley 102, can be minimized due to the intermittent sensing of the position of the belt 10 by the belt position sensor assembly 170. Foreign material stuck to the pulley 102 will affect the measured capacitance of both belt reference sensor 171 and belt position sensor 172, but since the belt 10 is only sensed for an arc portion of each revolution of the pulley 102 corresponding to the amount of belt wrap around the pulley 102, such as between 0°-180°, while the foreign material stuck to the pulley lagging 103 will be sensed continuously, the control system 200 can differentiate between the two and filter out or otherwise compensate for the effects of such foreign material and obtain accurate information regarding the presence and position of the belt 10.

The control system 200 can also use information from both the belt position sensor assembly 170 and the rotary encoder 222 as a check to confirm whether there is a malfunction, such as if component of the control system 200, such as the belt position sensor assembly 170, fails or is otherwise not operating properly. For example, the information received or derived from the belt position sensor assembly 170 and rotary encoder 222, such as the direction of rotation of the pulley 102, may be redundant and therefore can be used by the control system 200 as a check to ensure the belt position sensor assembly 170 and/or the rotary encoder 222 are operating properly. In some cases, fouling of the pulley 102 over time caused by foreign material sticking to the lagging 103, such as material being transported by the belt 10, could reduce the accuracy of the belt position sensor assembly 170, and by comparing the information detected by belt position sensor assembly 170 and rotary encoder 222, the control system 200 can detect potential error or fault conditions and notify a user accordingly.

The control system 200 may also be configured to detect potential issues with the belt tracker 100, including improper installation. In general, a belt tracker is most effective when it has sufficient contact with the conveyor belt during belt travel to induce enough friction to direct the belt 10 in the desired direction. In some installations, such as when the belt tracker 100 is installed along a return run 16 of the belt 10, sufficient friction will be present when the belt 10 contacts at least 1/12 of the circumference of the pulley 102 or pulley lagging 103. Stated differently, sufficient friction will be present when the arc of contact between the belt 10 and the pulley 102 or pulley lagging 103, i.e., the belt wrap 32, extends for a contact angle of approximately thirty degrees, as shown in FIG. 17. However, in some installations, such as when the belt tracker 100 is positioned along a top run 15 of the conveyor belt, sufficient friction may be present with little or no belt wrap.

Advantageously, the control system 200 can be configured to detect the amount of belt wrap around the pulley 102. For example, the belt position sensor assembly 170 mounted to the pulley 102 detects the presence of the belt 10 intermittently with every revolution of the pulley 102 as shown in FIG. 18. Each pulse of belt position signal 402 corresponds to the presence of the belt 10, with the amplitude of each pulse indicating the relative position of the belt 10 along a longitudinal extent of the belt position sensor assembly 170. The duration of the pulse (PW) relative to the duration of each cycle between leading edges of adjacent pulses (T), i.e., the duty cycle (which equals PW/T), corresponds to the amount of belt wrap 32 about the pulley 102. In addition, the encoder 222 also detects when each rotation of the pulley 102 is completed, which information can be used to determine the duration of each cycle (T), or to verify the calculation of the duration of each cycle between leading edges of adjacent pulses detected by the belt position sensor assembly 170 is accurate. Accordingly, the control system 200 can determine whether the amount of belt wrap 32 falls below a certain threshold, such as 1/12 (30 degrees/360 degrees), corresponding to an arc of contact of approximately 30 degrees. In addition, the control system 200 can determine whether the amount of belt wrap 32 is above a certain threshold, such as an arc of contact of greater than a value in the range of 60 to 175 degrees. If the duty cycle is above or below the predetermined threshold, the control system 200 can trigger an alarm or transmit a message to a user that the belt tracker 100 lacks sufficient belt wrap 32, has too much belt wrap 32, or more generally is not correctly installed so that the belt wrap 32 is proper.

As shown in FIG. 17, the shifting movement of the belt tracking apparatus 100 in the fore and aft or upstream and downstream directions of the shiftable end portion 104 of the pulley 102 in many installations is recommended to be along line A (and not line B), i.e. perpendicular to a median line 34 of the arc of contact or belt wrap 32 between the belt 10 and pulley 102, which helps to ensure that the belt tracker 100 has a similar amount of contact and friction with the belt 10 when shifted in both the upstream and downstream directions without unduly increasing tension on the belt 10. Stated differently, the belt wrap 32 should generally be positioned such that the center of the belt wrap 32 is incident with a vertical plane defined by the longitudinal axis L and the vertical direction 28. The control system 200 can compare information from the belt position sensor assembly 170 regarding the presence of the belt 10 with the relative position between the rotatable and stationary or partially rotatable control circuitry portions 204, 206 detected by the encoder 222 to determine whether the orientation of the belt wrap 32 around the pulley 102 is in the appropriate position shown in FIG. 17, such as with the median line 34 of the belt wrap parallel to the pivot axis P or within a threshold range on either side thereof. For example, if the belt position sensor assembly 170 detects the presence of the belt 10 with every revolution of the pulley 102 and the encoder 222 outputs a signal corresponding with when the belt position sensor assembly 170 and rotatable control circuitry portion 204 completes a revolution, such as in the position of the belt tracking apparatus 100 shown in FIG. 3, the signals can be compared to determine if the belt wrap 32 is detected and centered when a revolution of the belt position sensor assembly 170 and rotatable control circuitry portion 204 is completed. If the belt position sensor assembly 170 signal is sufficiently out of sync with the encoder 222 signal, the control system 200 can output an alarm or a notification to a user indicating that the belt tracker 100 is installed in an incorrect orientation.

The control system 200 may also be configured to track and record historical information regarding the belt and the belt tracker. For example, the control system 200 may detect whether the belt 10 is frequently tracking to one side of the roller beyond a predetermined threshold and similarly if the shiftable end portion 104 of the pulley 102 is frequently positioned in a downstream or upstream direction beyond a predetermined threshold, indicating that the belt 10 or belt support structure may need maintenance. In addition, the control system 200 can detect when a belt 10 begins to mistrack in a way that is different than the belt 10 had been mistracking historically. For example, if a belt 10 typically mistracks to the left towards the shiftable end portion 104 of the pulley 102, and the belt 10 suddenly starts mistracking toward the pivot end portion 106, the control system 200 can send a warning or alert to a user to check on the conveyor system 30 to verify whether the conveyor system 30, the conveyor belt 10, such as a belt splice, or the belt tracking apparatus 100 need maintenance or adjustment. Changes in the amplitude of the belt position and/or reference signals 402, 400 and/or a signal-to-noise ratio thereof obtained from the belt position sensor assembly 170 may also be monitored and stored by the control system 200 for determining whether inspection, maintenance or repair is required. In addition, the control system 200 can be configured to monitor changes in the actuator 124 movement required correct the travel path of a mistracking belt 10. For example, the control system 200 can monitor a required actuation angle, i.e., the amount of rotation of the rotatable support shaft 114, an orientation of the actuation angle relative to the home position of the rotatable support shaft 114, and/or a number of revolutions of the pulley 102 required to direct a mistracking belt 10 from a particular detected belt edge position on the pulley 102 back to the correct travel path.

An alternative embodiment of a belt tracker 500 shown in FIGS. 19-24 will now be described, which is similar in structure and function to the belt tracker 100, except as may be apparent from the description below. In general, the primary differences pertain to the support assembly 510, actuator assembly 528, pulley assembly 508, and sensor assembly 570. For example, as shown in FIG. 20, the sensor assembly 570 is mounted to the pulley 502 at the end portion 506 of the pulley assembly 508, rather than the opposite shiftable end portion 504. As a result, the control circuitry 202, including rotatable control circuitry portion 204 and the stationary control circuitry portion 206 are mounted in the internal space 509 of the pulley 502 extending about stationary support shaft 512 at the pivot end portion 506. This allows the actuator assembly 528, the control circuitry 202, and the stationary support shaft 512 to have the same components and configuration and to be assembled as a module, regardless of the length of the pulley assembly 508, and only different lengths of rotatable support shafts 514 are needed to accommodate different lengths of pulley assemblies 508 as may be required for conveyor belts 10 of different widths. Such modularization allows for more efficient production. In addition, installation is simplified by allowing a single electrical connection to power source 212 that enters the pulley assembly 508 through a central through opening 513 in the stationary support shaft 512, as all the components requiring electrical power are on the same lateral side of the pulley assembly 508. The support assembly 510 also includes an alternative embodiment of the motion converter 522 in the form of a lever 542 at the shiftable end portion 504 and an alternative embodiment of a support member at the end portion 506, which takes the form of leaf spring support assembly 520. The motion converter 522 and leaf spring support assembly 520 allow shifting of the shiftable end portion 504 generally in the fore and aft directions 24, 25 along an arcuate path illustrated in FIG. 24, which can allow for a reduction in tension induced by the belt tracker 500 on the belt 10 relative to other belt tracker travel paths when the shiftable end portion 504 is not shifted in an arcuate path generally in the fore or aft directions 24, 25. Other differences will be described in further detail below.

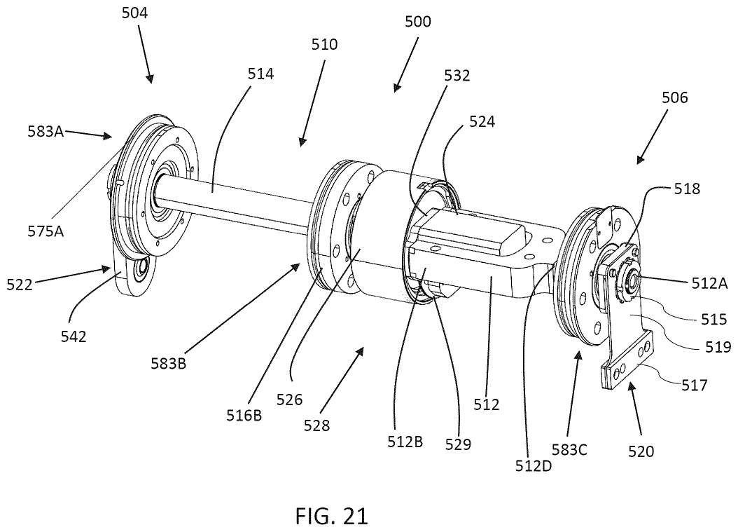

As shown in FIGS. 19-24, the belt tracking apparatus 500 has a pulley assembly 508, including the pulley 502 having an annular or cylindrical pulley body 502A, and optionally pulley lagging 503 thereon to form an annular or cylindrical wall or wall assembly of the pulley 502, being mounted for rotation about the pulley longitudinal axis L to a support assembly 510. As best shown in FIG. 21, the support assembly 510 includes a support shaft 512 that is referred to as stationary in that it is non-rotatable about its longitudinal axis. The stationary support shaft 512 extends generally along the lateral direction 26 from the pivot end portion 506 of the pulley assembly 508. The support assembly 510 also includes a rotatable support shaft 514 that extends generally along the lateral direction 26 from the opposite shiftable end portion 504 of the pulley assembly 508. Together, the shafts 512, 514 support the pulley 502 for rotation thereabout via roller bearing assemblies 516A-C mounted on the support shafts 512, 514 relative to a stationary conveyor system support frame or other external support structure (not shown).

In particular, as shown in FIG. 22, one roller bearing assembly 516A is mounted on the stationary support shaft 512 to extend therearound at end portion 506 of the pulley 502 between the opposite ends 512A and 512B of the stationary shaft 112. Roller bearing assemblies 516B and 516C are also mounted about the rotatable support shaft 514 to extend therearound adjacent either end 514A and 514B thereof. The outer roller bearing assemblies 516A and 516C are part of end cap assemblies 583A, 583C each positioned in the interior end openings 507A, 507B of the pulley body 502A so as to be rotatable with the pulley body 502A. Intermediate bearing assembly 516B is part of a similarly configured intermediate rotatable support assembly 583B. Roller bearing assemblies 516A-C are similarly configured as roller bearing assembly 116A-C described above.

End cap assemblies 583A and 583C of the pulley assembly 508 are similarly configured as end cap assemblies 183A and 183C. However, as shown in FIGS. 19 and 22, one or both of the end plates 575A, 575B may include one or more channels or bores 589 formed therein that have a portion that extends laterally inwardly from a laterally outer facing surface of the end plate 575A, 575B and then has a portion that continues radially outwardly to an outer radial flange edge of sleeve portion 585, such that each channel 589 provides a path for injection of pressurized air or another gas or fluid for assisting with the installation of lagging 503 about the pulley 502. In particular, by injecting air into the channels 589, the air exits the radially extending portions of the channels 589 at spaced apart locations about the circumference of the sleeve portion 585 and provides an air gap between the lagging 503 and the end plate 575A, 575B and the outer surface of the pulley 502, which reduces friction therebetween and eases the sliding of the lagging 503 about the pulley 502 during installation thereof.

As shown in FIGS. 20-23, stationary support shaft 512 has its laterally inner forked end 512B disposed in internal space 509 of the pulley annular or cylindrical body 502A and is fixedly connected at its other externally protruding annular or cylindrical end 512A to a support assembly in the form of universal or leaf spring support assembly 520 that allows the stationary support shaft 512 to pivot about a generally vertical pivot axis P that extends along a central longitudinal axis of the elongate leaf spring plate 519 and orthogonally to the pulley longitudinal axis L. The leaf spring support assembly 520 includes a laterally inner receiving plate 518, an elongate leaf spring plate 519, fasteners including a washer and a threaded retaining nut 515, and leaf spring mounting plates 517. More particularly, laterally outer cylindrical end 512A of stationary support shaft 512 extends through circular openings in the receiving plate 518 and elongate leaf spring plate 519. The elongate leaf spring plate 519 supports the stationary support shaft 512 relative to a conveyor support structure to which the elongate leaf spring plate 519 is connected with fasteners via the leaf spring mounting plates 517 positioned to be secured or clamped on opposite sides of a lower end of the leaf spring plate 519. The leaf spring plate 519 is sized such that it has sufficient rigidity to resist compressive forces along its length while having sufficient flexibility to allow a sufficient amount of both twisting and bending to accommodate shifting of the pulley assembly 508 generally upstream and downstream. In particular, the elongate leaf spring plate 519 can twist about its longitudinal vertical axis to allow movement of the driven shiftable end portion 504 of the pulley assembly 508 in a generally arcuate path with a primary directional component in the fore or aft directions 24, 25. In addition, the upper end portion of the elongate leaf spring plate 519 can bend laterally inwardly or outwardly about its lower end portion to allow the driven shiftable end portion 504 of the pulley assembly 508 to shift with a smaller directional component in the vertical direction 28, as shown in FIG. 24. In this manner, the leaf spring plate 519 allows for a more universal motion of the pulley end portion 506 as the pulley end portion 504 is driven in fore or aft directions 24, 25. Advantageously, the leaf spring support assembly 520 biases the pulley assembly 508 back toward a neutral orientation of the belt tracker 500 from a generally upstream or downstream shifted orientation of the pulley assembly 508.

As shown in FIGS. 21-23, the stationary support shaft 512 of support assembly 510 includes a forked or U-shaped laterally inner end 512B that extends along opposing sides of the actuator 524 to an input flange or end plate 531 to which actuator 524 is mounted. As shown FIG. 23, the stationary support shaft 512 also includes laterally outwardly facing flat surfaces 512C, 512D at a base of the U-shaped laterally inner end 512B to which stationary control circuitry portion 206 may be mounted. The actuator assembly 528 is similar to actuator assembly 128 including electrically powered actuator 524 and transmission 526, and further includes a position sensor 224 in the form of magnetic field interface integrated circuit 529 and target member 530 as described above for detecting the rotational displacement of the rotatable components of the support assembly 510 and actuator assembly 528, i.e. drive shaft 524A, transmission 526, and/or rotatable support shaft 514, which all rotate together when driven by the actuator 524.

The rotatable support shaft 514 extends from the transmission 526 in the pulley internal space 509 and laterally outwardly beyond the shiftable end portion 504 of the pulley assembly 508 for supporting the shiftable end portion 504 relative to the conveyor system support frame. The rotatable support shaft 514 is connected to the conveyor system support frame via a shiftable connection in the form of motion converter 522 which includes lever or link 542 adjacent the shiftable end portion 504 to allow shifting of the support assembly 510 and pulley assembly 508 generally in the fore and aft directions 24, 25 (i.e. generally upstream and downstream relative to belt travel direction 12) about the pivot axis P of the leaf spring support assembly 520, although due to the resilient nature of the elongate leaf spring plate 519, the orientation of the pivot axis P can shift as the elongate leaf spring plate 519 twists and/or bends to accommodate the movement of the shiftable end portion 504 and allow for the pulley end portion 506 to undertake a more universal motion, as previously mentioned. For example, the lever 542 is configured for converting rotational motion of the rotatable shaft 514 about the longitudinal axis L to an arcuate movement of the shiftable end portion 504 having directional components in the fore or aft directions 24, 25, as well having smaller directional components in the vertical direction 28 and the lateral direction 26.

The lever 542 is fixedly mounted to the laterally outer end portion 514A of rotatable support shaft 514. As shown in FIG. 22, the lever 542 includes a through opening 543 at its upper end that is sized and configured to receive end portion 514A of the rotatable support shaft 514 therein. Both the through opening 543 and the end portion 514A rotatable support shaft 514 include corresponding laterally inwardly inclined surfaces 514C, 543C to allow the lever 542 to be fixed against rotation about the rotatable support shaft 514. In particular, by threading threaded retaining nut 515 on the threaded end portion 514A of rotatable support shaft 514, the lever 542 is urged laterally inwardly over the gradually increasing circumference of the end portion 514A of the rotatable support shaft 514 with the corresponding laterally inwardly inclined surfaces 514C, 543C in mating engagement with one another. The elongate body of the lever 542 includes a lower through opening 544 at its opposite end in which a bearing 545, such as a radial spherical plain bearing, is received. A mounting shaft fixed to a support structure of the conveyor system (not shown) is received in the central opening 545A of the bearing 545 for supporting the shiftable end portion 504 of the belt tracker 500 via the lever 542. As shown in FIG. 24, the bearing 545 allows for rotational movement of the lever 542 and the pulley assembly 508 in either rotary direction about pivot axis P_{L}, which extends generally parallel to the lateral direction 26 through the central opening 545A of the bearing 545, along an arcuate path 550 with directional components in the fore and aft direction 24, 25 and vertical direction 28. The spherical plain bearing 545 also allows for limited movement of the driven shiftable end portion 504 in the lateral direction 26 to accommodate the downstream or upstream movement of the pulley assembly 508 generally about the leaf spring plate 519 including about its pivot axis P due to the fixed connection of stationary support shaft 512 with the leaf spring support assembly 520. In other forms, the pulley assembly 508 may be supported by different forms of shiftable and/or pivot connections at either end portion 504, 506 thereof such that the driven shiftable end portion 504 may be configured to move in a path that is linear or a path that has linear and arcuate segments.

The belt tracker 500 similarly includes one or more sensors for sensing the presence and/or position of an outer or lateral edge 20 of the belt 10. In particular, the belt position sensor assembly 570 is mounted at the end portion 506 of the pulley assembly 508. The belt position sensor assembly 570 is oriented on the surface 505 of the pulley 502 such that the belt edge 20 is positioned over the sensor assembly intermittently as the pulley 502 rotates about its longitudinal axis L. The belt position sensor assembly 570 may be identical to belt position sensor assembly 170 so that it is integrated in or with the wall or wall assembly 102B of the pulley 502. In other forms, belt position sensor assembly 570 may have the configuration shown in FIGS. 25 and 26 and as described in further detail above. As shown in FIG. 20, the belt position sensor assembly 570 is mounted at the end portion 506 of the pulley assembly 508 with the reference sensor electrodes 171A and belt position sensor electrodes 172A extending parallel to the longitudinal axis L of the pulley 502. The belt position sensor assembly 570 is sized and configured such that the belt 10 will be positioned over the shorter reference sensor electrodes 171A, which only extend a short distance away from the body laterally inner edge 170B to their other opposite ends 171C, during normal operation of the belt 10 even when the belt is mistracking towards the shiftable end portion 504 away from the end portion 506 on which the belt position sensor assembly 570 is mounted. By contrast, the longer belt position sensor electrodes 172A extend proximately to the laterally outer edge 170C of the generally rectangular body 170A of the belt position sensor assembly 570 so that the other opposite ends 172C are at or closely adjacent to the laterally outermost extent of the end portion 506 at the end of the pulley 502 to allow the edge 20 of the belt 10 to be detected when the belt is mistracking towards the end portion 506.

While there have been illustrated and described particular embodiments of the present invention, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. A conveyor belt tracking apparatus for urging a mistracking conveyor belt of a conveyor system back toward a correct travel path, the conveyor belt tracking apparatus comprising:
a rotatable pulley for engaging the conveyor belt and rotating as the conveyor belt travels in a downstream travel direction with the pulley having a neutral position when the conveyor belt is traveling along the correct travel path;
a support assembly configured to operatively mount the pulley for rotation thereabout with a longitudinal axis of the pulley extending transversely with respect to the downstream travel direction of the conveyor belt; and
a sensor integrated with the pulley for rotation therewith and arranged for detecting a position of a portion of the conveyor belt to allow the pulley to be shifted from its neutral position when the detected position of the conveyor belt portion indicates the conveyor belt is not traveling along the correct travel path.

2. The conveyor belt tracking apparatus of claim 1, wherein the pulley comprises an annular body and has lagging extending about the annular body and the sensor is connected to the pulley so that the sensor is integrated in or with an annular wall or wall assembly of the pulley.

3. The conveyor belt tracking apparatus of claim 2, wherein the lagging is of a rubber or polymeric material and comprises an additive or additional components to increase an electrical conductivity of the lagging relative to an electrical conductivity of the rubber or polymeric material alone for dissipating or directing away a static charge from the pulley.

4. The conveyor belt tracking apparatus of claim 1, wherein the pulley comprises an annular body including an internal space therein and an actuator is mounted to extend within the internal space of the pulley.

5. The conveyor belt tracking apparatus of claim 4, wherein the actuator is an electric motor.

6. The conveyor belt tracking apparatus of claim 4, wherein the support assembly comprises a rotatable support shaft extending laterally outwardly from a driven end portion of the pulley, wherein the rotatable support shaft is connected to the actuator to allow the actuator to rotate the rotatable support shaft for shifting the pulley from the neutral position thereof.

7. The conveyor belt tracking apparatus of claim 6, wherein the support assembly comprises a motion converter operably connected to the rotatable support shaft, the motion converter configured to convert rotation of the rotatable support shaft to a generally upstream or downstream movement of the driven end portion of pulley.

8. The conveyor belt tracking apparatus of claim 6, wherein the support assembly comprises a non-rotatable support shaft extending laterally outwardly from an opposite end portion opposite from the driven end portion, wherein the non-rotatable support shaft is operably connected to a shiftable support member to allow the driven end portion to be shifted further upstream or downstream than the opposite end portion.

9. The conveyor belt tracking apparatus of claim 1, wherein the pulley further comprises a metallic layer attached to a belt facing surface of the pulley, wherein the metallic layer is configured to provide an electrically conductive path through the support assembly to ground to dissipate a static charge on the pulley.

10. The conveyor belt tracking apparatus of claim 1, wherein the pulley is of an insulative and radiotransparent material.

11. The conveyor belt tracking apparatus of claim 1, further comprising a control system including the sensor, wherein the control system is configured to determine a belt travel direction of the conveyor belt based on signals output by the sensor and to reverse an actuation direction of the actuator to compensate for a change in the belt travel direction.

12. The conveyor belt tracking apparatus of claim 1, wherein the sensor is positioned at or adjacent to an end portion of the pulley such that an outer lateral edge of the conveyor belt travels intermittently over the sensor as the pulley rotates.

13. The conveyor belt tracking apparatus of claim 1, wherein the sensor comprises a capacitive sensor comprising a pair of electrodes, wherein each electrode of the pair of electrodes has an elongate strip configuration with the electrodes being arranged in parallel longitudinally extending rows that extend laterally along a length of the pulley.

14. The conveyor belt tracking apparatus of claim 1, wherein the pulley comprises an annular body including an internal space therein and control circuitry is mounted to extend within the internal space of the pulley, wherein the control circuitry comprises a rotatable portion that is connected to the rotatable pulley for rotation therewith;
wherein the sensor is communicatively connected to the rotatable portion of the control circuitry.

15. The conveyor belt tracking apparatus of claim 14, wherein the control circuitry comprises a stationary or partially rotatable portion operably connected to a support shaft of the support assembly and spaced from the rotatable portion of the control circuitry;
wherein the rotatable portion and the stationary or partially rotatable portion of the control circuitry each comprise a communication module to allow at least one of the rotatable portion and the stationary or partially rotatable portion of the control circuitry to communicate data wirelessly with at least an other of the rotatable portion and the stationary or partially rotatable portion of the control circuitry.

16. The conveyor belt tracking apparatus of claim 1, further comprising a control system including the sensor, wherein in response to the shifting of the pulley from its neutral position, the sensor generates signals regarding the position of the conveyor belt portion to allow the control system to determine whether the conveyor belt is being redirected back toward the correct travel path.

17. The conveyor belt tracking apparatus of claim 6, further comprising a control system including the sensor and a position sensor operable to detect a rotational displacement of the rotatable support shaft, wherein the control system is configured to determine a position of an end portion of the pulley based on the detected rotational displacement of the rotatable support shaft.

18. The conveyor belt tracking apparatus of claim 1, further comprising a control system including the sensor, wherein the control system is configured to compensate for a presence of foreign material attached to the pulley by comparing an output of the sensor when the position of the conveyor belt portion is detected to an output of the sensor when the sensor does not detect the position of the conveyor belt portion.

19. A conveyor belt tracking apparatus for urging a mistracking conveyor belt of a conveyor system back toward a correct travel path, the conveyor belt tracking apparatus comprising:
a rotatable pulley for engaging the conveyor belt and rotating as the conveyor belt travels in a downstream travel direction with the pulley having a neutral position when the conveyor belt is traveling along the correct travel path, the pulley having an annular pulley body including an internal space therein;
a support assembly extending through the internal space configured to operatively mount the pulley for rotation thereabout with a longitudinal axis of the pulley extending transversely with respect to the downstream travel direction of the conveyor belt;
a shiftable end portion of the pulley configured to be shifted upstream or downstream further than an opposite end portion of the pulley;
a sensor configured to detect whether the conveyor belt is traveling along the correct travel path; and
an electrically powered actuator mounted within the internal space of the pulley for powered driving of the shiftable end portion of the pulley when the sensor detects that the conveyor belt is not traveling along the correct travel path with the powered driving of the shiftable end portion of the pulley causing the conveyor belt to travel back toward the correct travel path.

20. The conveyor belt tracking apparatus of claim 19, wherein the electrically powered actuator is an electric motor.

21. The conveyor belt tracking apparatus of claim 19, further comprising a control system including the sensor, wherein the control system is configured to cause the electrically powered actuator to drive the shiftable end portion of the pulley when the sensor detects that the conveyor belt is not traveling along the correct travel path.

22. The conveyor belt tracking apparatus of claim 19, wherein the support assembly comprises a rotatable support shaft extending laterally outwardly from the shiftable end portion of the pulley, wherein the rotatable support shaft is operably connected to the electrically powered actuator to allow the electrically powered actuator to rotate the rotatable support shaft for shifting the shiftable end portion of the pulley.

23. The conveyor belt tracking apparatus of claim 22, wherein the support assembly comprises a motion converter operably connected to the rotatable support shaft, the motion converter configured to convert rotation of the rotatable support shaft to a movement of the shiftable end portion upstream or downstream.

24. The conveyor belt tracking apparatus of claim 22, wherein the pulley comprises an opposite end portion opposite from the shiftable end portion, the support assembly comprises a non-rotatable support shaft extending laterally outwardly from the opposite end portion of the pulley, and the non-rotatable support shaft is operably connected to a shiftable support member to allow the shiftable end portion to be shifted further upstream or downstream than the opposite end portion.

25. The conveyor belt tracking apparatus of claim 24, wherein the shiftable support member comprises a leaf spring to which the non-rotatable support shaft is operably connected and the leaf spring is configured to twist and bend to allow the shiftable end portion of the pulley to be shifted further upstream or downstream than the opposite end portion.

26. The conveyor belt tracking apparatus of claim 19, wherein the sensor is connected to the pulley to rotate therewith.

27. The conveyor belt tracking apparatus of claim 20, further comprising control circuitry mounted within the internal space of the rotatable pulley;
wherein the control circuitry comprises a rotatable portion communicatively connected to the sensor for processing signals therefrom, the rotatable portion being operably connected to the rotatable pulley such that the rotatable portion rotates together with the rotatable pulley.

28. The conveyor belt tracking apparatus of claim 27, wherein the control circuitry comprises a stationary or partially rotatable portion operably connected to a support shaft of the support assembly and spaced from the rotatable portion of the control circuitry, wherein the rotatable portion and the stationary or partially rotatable portion of the control circuitry each comprise a communication module to allow at least one of the rotatable portion and the stationary or partially rotatable portion of the control circuitry to communicate data wirelessly with at least an other of the rotatable portion and the stationary or partially rotatable portion of the control circuitry in the pulley internal space.

29. The conveyor belt tracking apparatus of claim 27, further comprising a position sensor operable to detect a rotational displacement of the actuator, wherein the control circuitry is configured to determine a position of the shiftable end portion of the rotatable pulley based on a detected rotational displacement of the actuator.

30. A conveyor belt tracking apparatus for urging a mistracking conveyor belt of a conveyor system back toward a correct travel path, the conveyor belt tracking apparatus comprising:
a rotatable pulley for engaging the conveyor belt and rotating as the conveyor belt travels in a downstream travel direction with the pulley having a neutral position when the conveyor belt is traveling along the correct travel path, wherein the pulley comprises an annular pulley body including an internal space therein;
a support assembly extending through the internal space configured to operatively mount the pulley for rotation thereabout with a longitudinal axis of the pulley extending transversely with respect to the downstream travel direction of the conveyor belt;
a shiftable end portion of the pulley configured to be shifted upstream or downstream further than an opposite end portion of the pulley; and
control circuitry including a sensor arranged for detecting a position of a portion of the conveyor belt;
wherein the control circuitry comprises a rotatable portion communicatively connected to the sensor for processing signals therefrom and the rotatable portion is mounted within the internal space of the annular pulley body and is connected to the pulley to rotate therewith.

31. The conveyor belt tracking apparatus of claim 30, further comprising an actuator mounted within the internal space for shifting the shiftable end portion of the pulley when the sensor detects that the conveyor belt is not traveling along the correct travel path to urge the conveyor belt to travel back toward the correct travel path.

32. The conveyor belt tracking apparatus of claim 30, wherein the sensor is connected to the pulley to rotate therewith.

33. The conveyor belt tracking apparatus of claim 30, wherein the control circuitry comprises a stationary or partially rotatable portion operably mounted within the internal space, wherein the rotatable portion and the stationary or partially rotatable portion of the control circuitry each comprise a communication module to allow at least one of the rotatable portion and the stationary or partially rotatable portion of the control circuitry to communicate data wirelessly with at least an other one of the rotatable portion and the stationary or partially rotatable portion of the control circuitry.

34. The conveyor belt tracking apparatus of claim 33, wherein the stationary or partially rotatable portion of the control circuitry is configured to provide power to the rotatable portion of the control circuitry via induction.

35. The conveyor belt tracking apparatus of claim 33, wherein the rotatable portion of the control circuitry and the stationary or partially rotatable portion of the control circuitry each comprise a circuit board, wherein the circuit boards are mounted to extend generally parallel to one another and transverse to the longitudinal axis of the rotatable pulley to allow for relative rotational movement therebetween.

36. The conveyor belt tracking apparatus of claim 30, wherein the control circuitry is configured to determine at least one of a position, speed and a direction of rotation of the rotatable portion of the control circuitry.
